(19) United States
(12) Patent Application Publication
(10) Pub. No.: US 2016/0128367 A1
(43) Pub. Date: May 12, 2016

(54) Stable, Convenient Whole Food Nutritional Supplement

(71) Applicant: Vita Vis Nutrition, Inc., San Mateo, CA (US)

(72) Inventor: Heidi L. Huntsman, San Mateo, CA (US)

(21) Appl. No.: 14/933,175

(22) Filed: Nov. 5, 2015

Related U.S. Application Data
(60) Provisional application No. 62/076,101, filed on Nov. 6, 2014.

(51) Int. Cl. A23L 1/164; A23L 1/212; A23L 1/20

(52) U.S. Cl. CPC A23L 1/164; A23L 1/2005; A23L 1/2128; A23V 2002/00

(57) ABSTRACT

The disclosure relates to shelf-stable food products that are whole food based, made with fresh produce, and contain high fiber, complex protein, low sugar, low calories, without any concentrates, extracts, powders or artificial ingredients; and the process of making the same.

### RELATED APPLICATIONS

This application claims priority to, and the benefit of, U.S. Provisional Application No. 62/076,101, filed on Nov. 6, 2014, which is incorporated herein by reference in its entirety.

### FIELD

The present invention relates generally to shelf-stable food products that are whole food based.

### BACKGROUND

The United States and many other developed countries have undergone significant changes in dietary habits since the Second World War. Many of these changes have been detrimental, such as the abundance of highly processed foods, foods high in sugar, high in fat, and/or lacking many of the nutrients (such as protein, fiber, and complex carbohydrates) that are found in unprocessed or minimally processed whole food sources. These changes have caused many health conditions, most notably perhaps are heart disease, type 2 diabetes, and obesity. It is estimated that in 2014 $190 B was spent in the U.S. on obesity related medical costs, and these numbers are only getting bigger as the obese population in the U.S. continues to grow.

In recent years, many food companies have made an effort to make healthier packaged food. Unfortunately, it can be challenging to make a convenient, shelf-stable product that is as highly nutritious as the whole food from which it originated. Accordingly, there is a need for convenient, shelf-stable, ready to consume, and highly nutritional food products.

### SUMMARY

Disclosed herein are shelf-stable food products that are whole food based, made with fresh produce, and contain high fiber, multiple sources of complex vegetable based protein, low sugar, low calories, without any concentrates, extracts, powder or artificial ingredients.

In accordance with one exemplary embodiment, provided herein is a food product that includes, in each serving, about 2-10 grams of protein from a first whole food source, about 2-10 grams of fiber from a second whole food source, and about 2-15 grams of sugar from at least one of whole fruits and whole vegetables, where the food product is a thermally processed and shelf-stable food product. For example, the serving is a 3 ounce (85 gram) serving. For example, the serving is a 8 ounce (226 gram) serving. For example, the serving is between 3 to 8 ounces (e.g., 4, 5, 6, 7 ounces).

Also provided herein is a food product that includes, in each serving, about 2-10 grams of protein from a first whole food source, about 2-10 grams of fiber from a second whole food source, and about 2-15 grams of sugar from at least one of whole fruits and whole vegetables, where the food product is a high pressure processed food product. For example, the serving is a 3 ounce (85 gram) serving. For example, the serving is a 8 ounce (226 gram) serving. For example, the serving is between 3 to 8 ounces (e.g., 4, 5, 6, 7 ounces).

In some embodiments, the food product described herein include, in each serving, about 2-10 grams of protein from a first whole food source, about 3-10 grams of fiber from a second whole food source, and about 2-15 grams of sugar from at least one of whole fruits and whole vegetables, where the food product is a thermally processed or a high pressure processed food product, and where the food product is free of animal protein. For example, the serving is a 3 ounce (85 gram) serving. For example, the serving is a 8 ounce (226 gram) serving. For example, the serving is between 3 to 8 ounces (e.g., 4, 5, 6, 7 ounces).

For example, the first whole food source is legume, whole grain, seed, nut, or any combination thereof.

For example, the second whole food source is legume, whole grain, seed, husk, nut, root vegetable, leafy green vegetable, fresh herb, citrus fruit, stone fruit, pome fruit or any combination thereof.

For example, the sugar includes fructose from at least one of whole fruits and whole vegetables, or the juices from at least one of whole fruits and whole vegetables.

In some embodiments, the legume is bean, pea or lentil, or any combination thereof. In some embodiments, the seed is chia seed, flax seed, perilla seed or psyllium seed, or any combination thereof. In some embodiments, the root vegetable is sweet potato, beet, yam, carrot, or any combination thereof.

The food product may also include about 0.5-2 grams of natural omega-3-fatty acid.

The food product may also include about 20-200 micrograms of natural folate.

The food product may also include one or more natural supplemental vitamins and/or minerals. For example, the vitamin and/or mineral are provided from one or more natural sources selected from the group consisting of a Vitamin B-9 source, a Vitamin C source, a Vitamin A source, a Vitamin K source, a Choline source, a Vitamin B6 source, a Calcium source, a Potassium source, a Magnesium source, a Manganese source, a Selenium source, a Zinc source, a Niacin source, a Phosphorus source, a Pantothenic Acid source, a Riboflavin source, a Thiamin source, and a Betaine source.

In an illustrative embodiment, the food product includes, in each serving, about 1,000-2,000 mg Calcium; about 800-2,000 IU Vitamin D; about 800-1,500 mg phosphorus; about 5-20 milligrams silica; about 200-1,000 micrograms Chromium; about 500-3,000 milligrams Vitamin C; about 800-1,200 Vitamin K1; and/or about 45-180 micrograms menaquinone 7 (MK7).

The pH of the food product is in the range of about 3.5 to about 5.5. In some embodiments, the pH is in the range of about 3.5 to about 4.5.

The food product can be in a form of a drink, a smoothie, a food blend, a frozen bar or popsicle, a sauce, a soup or a bar.

The food product is substantially free of one or more ingredients selected from the group consisting of artificial preservatives, artificial fiber, protein isolates, and artificial sweeteners.

The food product may include at least one organic food source (e.g., the first food source, the second food source, the whole fruits/vegetables).

The food product may include at least one conventional (i.e., non-organic) food source (e.g., first food source, the second food source, the whole fruits/vegetables).

Also provided herein is a process for producing the food product described herein. The process includes steps of a) measuring two or more whole food sources; b) cooking or softening certain of the whole food sources; c) combining the whole food sources; d) providing a mixture by blending the whole food resources; e) reducing the mixture into smaller particles; f) adding citrus juice to make the mixture acidic; g) pasteurizing the mixture for shelf stability, and h) packaging the mixture, thereby producing the food product. For example, pasteurizing the mixture is carried out by ultra-high temperature pasteurization, standard pasteurization, acidified food pasteurization (lower times/temperatures than standard), high pressure pasteurization, or in some cases retorting.

The process may also include a step of running the mixture through a sieve or a food mill before pasteurizing the mixture. Alternatively, the process may include a step of running the mixture through a series of blades to further reduce the particle size.

The process may also include a step of adjusting the pH of the food product. This adjusting the pH step can be performed either before or after pasteurizing the mixture. Adjusting the pH is carried out by adding an effective amount of a natural fruit or juice from at least one natural acidic fruit, either single strength or concentrated. For example, natural acidic fruit is lemon, lime, orange, mandarin, grape, pineapple, apple or any combination thereof.

The whole food source that can be used in the process can be legume, whole grain, seed, nut, husk, root vegetable, leafy green vegetable, fresh herb, and/or fruit.

The process does not include any steps of removing any fiber from the whole food source.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only and not intended to be limiting.

Other features and advantages of the invention will be apparent from the following detailed description and claims. The citation of any reference herein should not be deemed as an admission that such reference is available as prior art to the instant invention.

### DETAIL DESCRIPTION OF EXEMPLARY EMBODIMENTS

Certain exemplary embodiments will now be described to provide an overall understanding of the composition, manufacture, and use of the food products disclosed herein. Those of ordinary skill in the art will understand that the food products and methods specifically described herein are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The articles “a” and “an” are used herein to refer to one or to more than one (i.e., to at least one) of the grammatical object of the article. By way of example, “a whole food source” means one whole food source or more than one whole food source.

The terms “comprise,” “include,” and “have,” and the derivatives thereof, are used herein interchangeably as comprehensive, open-ended terms. For example, use of “comprising,” “including,” or “having” means that whatever element is comprised, had, or included, is not the only element encompassed by the subject of the clause that contains the verb.

All numerical designations (e.g., pH, temperature, time, concentration, and molecular weight, including ranges) are approximations which are varied (+) or (−) by increments of 1.0 or 0.1, as appropriate. It is to be understood, although not always explicitly stated that all numerical designations are preceded by the term “about.” It also is to be understood, although not always explicitly stated, that the reagents described herein are merely exemplary and that equivalents of such are known in the art.

As used herein, the term “whole food” refers to any food as it exists in nature; food that is unprocessed and unrefined. Generally these foods have not been exposed to any method of heat treatment, and do not contain added preservatives or flavoring such as salt, carbohydrate, fat or sugar, have not had components removed, such as fiber, pulp, or skin, have not had components isolated or concentrated, such as juices or sugars.

The term “natural” refers to having, constituting, or relating to an ingredient existing in nature or obtained from one or more whole food sources, as opposed to being artificial or synthetic.

As used herein, the term “thermally treated” refers to any exposure to a heat source in a way as to modify food (e.g., by flavor enhancement or change in texture and/or consistency) or as a way to sterilize a food product for safety and food quality purposes.

As used herein, “High Pressure Processing (HPP)” refers to a method of food processing where food is subjected to elevated pressures (up to 87,000 pounds per square inch or approximately 6,000 atmospheres), with or without the addition of heat, to achieve microbial inactivation or to alter the food attributes in order to achieve consumer-desired qualities. Pressure that inactivates most vegetative bacteria is above 60,000 pounds per square inch. HPP retains food quality, maintains natural freshness, and extends microbiological shelf life. The process is also known as high hydrostatic pressure processing (HHP) and ultra high-pressure processing (UHP). In a typical HPP process, the product is packaged in a flexible container (usually a pouch or plastic bottle) and is loaded into a high pressure chamber filled with a pressure-transmitting (hydraulic) fluid. The hydraulic fluid (normally water) in the chamber is pressurized with a pump, and this pressure is transmitted through the package into the food itself. Pressure is applied for a specific time, usually 3 to 5 minutes. The processed product is then removed and stored/distributed in the conventional manner. Because the pressure is transmitted uniformly (in all directions simultaneously), food retains its shape, even at extreme pressures. And because no heat is needed, the sensory characteristics of the food are retained without compromising microbial safety.

As used herein, the term “pasteurized” or “pasteurization” refers to any method of treating a food product or nutritional supplement with the intent to kill or eliminate the presence of bacteria, spores, viruses, fungi, etc., for food quality and safety purposes. These methods can include (but are not limited to) Conventional Pasteurization, Ultra High Temperature pasteurization (UHT), High Pressure Pasteurization (HPP), Retorting, Blanching, Canning, Aseptic Canning, or any other method of treating a low acid or acidified food as mandated by the FDA.

The term “blend” or “blending” refers to a process in which several distinct food products are mixed together to form a mostly homogenous product of particle size smaller than the original whole food product. The final product can be chunky or smooth, thick or thin. Blending can be accomplished with a blade (straight or rotating), a series of blades, a food mill or mesh filter, or a stirring device (either by hand or mechanically rotating).

As used herein, the term “solid food product” refers to a food product that contains less than 30% by weight of liquid, such as a bar, or baked good.

As used herein, the term “semi-solid food product” refers to a food product that has been prepared into a state, such as blended or pureed, so that it may be eaten with a spoon, sucked through a straw, drunk, or sipped. A “semi-solid food product” used herein generally contains about 30%-80% (e.g., about 30%, 35%, 40%, 45%, 50%, 55%, 60%, 65%, 70%, 75%, 80%) by weight of liquid.

As used herein, the term “serving size” refers to the amount of a food or drink that is generally served set forth in the guidelines by U.S. Food and Drug Administration (see Code of Federal Regulations Title 21). It is understood that amounts of ingredients or components in each food product described herein will change with the change of the serving size. It is also understood that the amounts of various ingredients or components in each food product described herein are based on the serving size. For example, the serving size of juices (and all variants) for infants and toddlers is 4 fluid oz; and the serving size of juices or fruit drinks for adults is 8 fluid oz. In some embodiments, the serving size is 3 oz (85 gram). In some embodiments, the serving size is 8 ounce (226 gram). In some embodiments, the serving size is between 3 to 8 oz (e.g., 4, 5, 6, 7 oz).

The term “refining step” (including chemical refining and physical refining steps) used herein refers to steps that are used to produce a food product with characteristics that consumers desire such as smoothness (i.e., small particle size), softness, consistency, and shelf-stability.

### Food Products

Provided herein are convenient, shelf-stable, ready to consume (eat or drink, e.g., in the form of a drink, a smoothie, a frozen bar or popsicle, a sauce, a soup or a bar), highly nutritional products that are made using 50%-90% natural whole food source or sources with liquid being the remaining percentage. The term “natural whole foods” refers to foods in their natural state as they are harvested from the plant that supported their growth. For example, for grains and legumes, this might mean husks, stalks, or pods removed, the food product dried, and then cooked with water or broth into an edible consistency. For most fruits and vegetables, this generally means fresh with minimal or no processing or preparation. For some highly perishable fruits and vegetables, such as leafy greens, bananas and mangos, it can also mean Individually Quick Frozen (IQF) as is used to lock in nutrients directly after harvesting, extending the nutritious life of the plants. Some vegetables, especially certain root vegetables, are generally cooked in a way to bring out their flavor and to give a desired consistency.

Most “readily available” packaged foods in the market, including those deemed “healthy,” have undergone fairly extensive processing and nutrient recombining (adding powders, concentrates, etc.) that changes the nutrient composition in the final food product. In particular, these existing so called healthy food products have the following problems.

First, much or most of the natural fiber in these food products is removed from the whole foods as they are processed. For instance, the skin, seeds, and much of the “pulp” are removed from the fruits and vegetables that are the components of many of the current food products on the market today, such as most packaged baby foods, packaged applesauce, and fresh juices. While these food products are fruit and/or vegetable based, most of the fiber, protein and other nutrients have been removed during processing, resulting in a final product with a much lower level of fiber, protein, and other nutrients than the whole foods themselves contained prior to processing.

Second, many packaged food products use fruit juice concentrates or highly concentrated fruit and/or vegetable purees to sweeten or add more intense flavor to the foods they are packaging. Many of the packaged fruit or packaged fruit and vegetable products available in the market are sweetened by adding fruit (or vegetable) juice concentrates, or concentrated fruit purees, greatly adding to the sweetness of the final product, but again resulting in a different nutrient balance or composition than the whole food sources prior to processing.

Third, many packaged foods “fortify” or enhance their products with either synthetic or isolated nutrients that are much simpler in structure than the complex array of nutrients found in a mixture of healthy natural whole foods. For instance, protein powder is often added to replace protein removed or destroyed during food processing. However, in general, powders contain more simple and less diverse proteins than what is found in natural whole food.

Moreover, many packaged food products are loaded with sugar. For example, one commercially available 16 oz juice touts almost 3 apples, in addition to portions of a handful of other fruits. While there is a picture of broccoli on the front, actual broccoli exists only in trace amounts. This juice contains 56 grams of sugar without any fiber.

In contrast, the food products described herein have demonstrated superior properties than any existing packaged food products on the market. In particular, the food products disclosed herein are shelf-stable, whole food based, made with fresh produce, and contain high fiber, complex proteins, low sugar, low calories, without any concentrates, extracts, powder or artificial ingredients. In other words, the food products described herein are as close to the natural state of the whole foods from which they were derived as possible, while also making them safe for human consumption as packaged goods. Fiber (skin and pulp) is not removed from the fruits and vegetables during processing. The ingredients of the food products described herein are always from fruits and vegetables that are fresh, or in some cases Individually Quick Frozen (IQF). In other words, all or most starting whole food sources used to produce the food product described herein are not pureed. Any juices added are the product of fresh fruits and/or vegetables and are single strength (SS) (100% or unconcentrated), and not from concentrate (NFC). Any grains, nuts, or seeds are whole or sprouted, not refined in any way. Grains, legumes, and some root vegetables may be cooked in water, oil (vegetable, olive, avocado, coconut, etc.) broth (vegetable or meat/poultry based), or coconut water for better consistency and flavor. An exception would be natural citrus juice used specifically to acidify the end product, which is natural, but may be in a concentrated form.

Compared to other existing packaged food products in the market, the food products described herein contain nutrients from whole food sources providing up to 1200% more fiber, up to 400% more protein, and 30% less sugar. In addition to being much healthier and more nutritious than those existing packaged food products, the food products described herein also have anti-inflammatory properties due to the selection of anti-inflammatory food used as primary ingredients, and a low Glycemic Index due to the low overall amount of sugar combined with the high fiber.

The food product of this disclosure provides nutrient balance, flavor, and color by including green leafy vegetables such as kale, spinach, collard greens and beet greens, root vegetables such as beets, carrots, yams and sweet potatoes, whole grains and sprouted grains, such as quinoa and ferro, legumes, such as beans (navy, lima, etc.) lentils, and peas, nuts, such as cashews, peanuts, hazelnuts and almonds, seeds, such as flax, psyllium (including husks), perilla and chia, squash, such as pumpkin, butternut or zuccini, cruciferous vegetables such as broccoli cauliflower, and Brussels sprouts; other vegetables such as green beans, asparagus and corn, fresh herbs, such as mint and rosemary, citrus, such as orange, lemon, lime and mandarins, berries, such as strawberries, raspberries, blackberries, mulberries and blueberries, melons, such as cantaloupe and honeydew, tropical fruits, such as bananas, pineapple, mango and papaya, Zingiberaceaes, such as ginger or turmeric, alliums, such as onion and garlic, capsicums, such as sweet peppers and chili peppers, coconut flesh, and fungi, such as mushrooms. Other nutrients may be added from plant sources such as algae or cyanobacterium such as spirulina.

The food products described herein contain in each serving about 2-10 grams of protein (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 3-10, 4-10, 5-10, 2-9, 3-9, 4-9 g) from a first whole food source, about 2-10 grams of fiber (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 3-10, 4-10, 5-10, 2-9, 3-9, 4-9 g) from a second whole food source, and about 2-15 grams of sugar (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.5, 11, 11.5, 12, 12.5, 13, 13.5, 14, 14.5, 15 g or about 3-14, 4-14, 5-14, 2-10, 3-10, 4-10 g) from at least one of whole fruits and whole vegetables, where the food product is a thermally processed and shelf-stable food product. The first whole food source and the second food source may be identical, similar with certain overlap, or completely different. In some embodiments, each serving is about 3 oz (85 gram). In some embodiments, each serving is about 4 oz (113 gram). In some embodiments, the serving size is 8 oz (226 gram). In some embodiments, the serving size is between 3 to 8 oz (e.g., 4, 5, 6, 7 oz).

Alternatively, the food products described herein include in each serving about 2-10 grams of protein (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 3-10, 4-10, 5-10, 2-9, 3-9, 4-9 g) from a first whole food source, about 2-10 grams of fiber (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 3-10, 4-10, 5-10, 2-9, 3-9, 4-9 g) from a second whole food source, and about 2-15 grams of sugar (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.5, 11, 11.5, 12, 12.5, 13, 13.5, 14, 14.5, 15 g or about 3-14, 4-14, 5-14, 2-10, 3-10, 4-10 g) from at least one of whole fruits and whole vegetables, where the food product is treated by high pressure processing (HPP). The first whole food source and the second food source may be identical, similar with certain overlap, or completely different. In some embodiments, each serving is about 3 oz (85 gram). In some embodiments, each serving is about 4 oz (113 gram). In some embodiments, the serving size is 8 oz (226 gram). In some embodiments, the serving size is between 3 to 8 oz (e.g., 4, 5, 6, 7 oz).

In some embodiments, the food products described herein contain in each serving about 2-10 grams of protein (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 3-10, 4-10, 5-10, 2-9, 3-9, 4-9 g) from a first whole food source, about 3-10 grams of fiber (e.g., about 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 g or about 4-10, 5-10, 3-9, 4-9 g) from a second whole food source, and about 2-15 grams of sugar (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.5, 11, 11.5, 12, 12.5, 13, 13.5, 14, 14.5, 15 g or about 3-14, 4-14, 5-14, 2-10, 3-10, 4-10 g) from at least one of whole fruits and whole vegetables. In some embodiments, the food product is a thermally processed and shelf-stable food product. Alternatively, the food product is a food product treated by HPP. The first whole food source and the second food source may be identical, similar with certain overlap, or completely different. In some embodiments, each serving is about 3 oz (85 gram). In some embodiments, the serving size is 8 oz (226 gram). In some embodiments, the serving size is between 3 to 8 oz (e.g., 4, 5, 6, 7 oz). In some embodiments, the food product is free of animal protein. In some embodiments, the food product is free of any animal product.

An exemplary first whole food source of the primary protein includes, but is not limited to, legumes in any form (dried, raw, hydrated, cooked, roasted, boiled, toasted, steamed, split, chopped, ground, pulverized or pureed), such as lentils of any color; beans (such as lima beans, kidney beans, navy beans or white beans), chickpeas, and peas of any color; whole grains in any form (whole, raw, sprouted, cooked, boiled, steamed, roasted, toasted, ground, pulverized or pureed), such as quinoa, amaranth, barley, faro, rye, buckwheat, and rice; cruciferous vegetables in any form (whole, skinned, raw, cooked, roasted, steamed, sautéed, baked, boiled, chopped, ground, frozen (including IQF), pulverized or pureed) such as broccoli, cauliflower and Brussels sprouts; other vegetables in any form (whole, skinned, raw, cooked, roasted, steamed, sautéed, baked, boiled, chopped, ground, frozen (including IQF), pulverized or pureed) such as corn; seeds in any form (whole, raw, sprouted, dried, cooked, roasted, boiled, steamed, toasted, ground, chopped, pulverized), such as flax, sunflower, pumpkin, perilla, sesame, hemp and chia seeds; nuts in any form (whole, raw, roasted, boiled, steamed, toasted, ground, chopped, pulverized, sliced), such as almonds, peanuts, cashews, walnuts, pecans, pistachios, pine nuts, macadamia nuts and hazelnuts; and any combination thereof.

An exemplary second whole food source of the fiber includes, but is not limited to, legumes in any form (dried, raw, cooked, roasted, boiled, toasted, steamed, split, chopped, frozen (including IQF), ground, pulverized or pureed), such as lentils of any color, beans (such as lima beans, kidney beans, navy beans or white beans) chickpeas and peas of any color; whole grains in any form (whole, raw, sprouted, cooked, boiled, steamed, roasted, toasted, ground, pulverized, or pureed), such as quinoa, amaranth, barley, faro, rye, buckwheat, and rice; seeds in any form (whole, raw, sprouted, dried, hydrated, cooked, frozen (including IQF), roasted, boiled, steamed, toasted, ground, chopped, pulverized), such as flax, sunflower, perilla, pumpkin, psyillium (including husks), sesame, hemp and chia seeds, and nuts in any form (whole, raw, roasted, boiled, steamed, toasted, ground, chopped, pulverized, frozen (including IQF), sliced), such as almonds, peanuts, cashews, walnuts, pecans, pistachios, pine nuts, macadamia nuts and hazelnuts; root vegetables in any form (whole, skinned, raw, cooked, roasted, steamed, sautéed, baked, boiled, chopped, ground, frozen (including IQF), pulverized or pureed) such as beets of any color, carrots of any color, potatoes of any color, sweet potatoes of any color, or yams of any color; cruciferous vegetables in any form (whole, skinned, raw, cooked, roasted, steamed, sautéed, baked, boiled, chopped, ground, frozen (including IQF), pulverized or pureed) including broccoli, cauliflower and Brussels sprouts; other vegetables in any form (whole, skinned, raw, cooked, roasted, steamed, sautéed, baked, boiled, chopped, ground, frozen (including IQF), pulverized or pureed) such as green beans, asparagus and corn; whole citrus fruit in any form (raw, segmented, sliced, chopped, pulverized, masticated, pureed, frozen (including IQF), cooked, boiled, steamed, roasted) such as limes, lemons, oranges, mandarins and grapefruit; pome fruits in any form (whole, raw, dried, dehydrated, cooked, boiled, frozen (including IQF), roasted, steamed, sautéed, baked, pureed, chopped, blended or pulverized) such as apples of any variety, pears of any variety, and Asian pears; stone fruits in any form (whole, raw, dried, dehydrated, cooked, frozen (including IQF), boiled, roasted, steamed, sautéed, baked, pureed, chopped, blended, pulverized or powdered), such as peaches, nectarines, cherries, apricots and plums of any color; tropical fruits in any form (whole, raw, dried, dehydrated, cooked, boiled, frozen (including IQF), roasted, steamed, sautéed, baked, pureed, chopped, blended, masticated, or pulverized), such as mangos, papayas, pineapple, or banana; berries in any form (whole, raw, dried, dehydrated, cooked, frozen (including IQF), boiled, roasted, steamed, sautéed, baked, pureed, chopped, blended or pulverized), such as strawberries, raspberries, blackberries, mulberries and blueberries, melons in any form (whole, raw, dried, dehydrated, cooked, frozen (including IQF), boiled, roasted, steamed, sautéed, baked, pureed, chopped, blended or pulverized), such as cantaloupe, watermelon and honeydew, leafy vegetables in any form (whole, raw, cooked, frozen (including IQF), boiled, roasted, steamed, sautéed, baked, pureed, chopped, blended or pulverized) such as kale, spinach, collard greens, lettuce of any variety, and beet greens; squash in any form (whole, raw, dried, dehydrated, cooked, boiled, roasted, steamed, frozen (including IQF), sautéed, baked, pureed, chopped, blended, or pulverized), such as acorn squash, yellow squash, zucchini, summer squash, pumpkin, and butternut squash; herbs in any form (whole, raw, dried, dehydrated, cooked, boiled, roasted, steamed, sautéed, baked, pureed, frozen (including IQF), chopped, blended, pulverized or powdered), such as mint, spearmint, sage, rosemary, thyme, or oregano; Zingiberaceaes in any form (whole, raw, dried, dehydrated, cooked, boiled, roasted, frozen (including IQF), steamed, sautéed, baked, pureed, chopped, blended, pulverized or powdered), such as ginger or turmeric, alliums in any form (whole, raw, dried, dehydrated, cooked, frozen (including IQF), boiled, roasted, steamed, sautéed, baked, pureed, chopped, blended, pulverized or powdered) such as shallots, onion of any variety and garlic, capsicums in any form (whole, raw, dried, dehydrated, cooked, boiled, roasted, frozen (including IQF), steamed, sautéed, baked, pureed, chopped, blended, pulverized or powdered), such as sweet peppers of any variety and chili peppers of any variety, coconut flesh in any form (whole, raw, dried, dehydrated, cooked, boiled, roasted, frozen (including IQF), steamed, sautéed, baked, pureed, chopped, blended, pulverized or powdered), fungi in any form (whole, raw, dried, dehydrated, cooked, boiled, roasted, steamed, sautéed, baked, frozen (including IQF), pureed, chopped, blended, or pulverized), such as mushrooms of any variety, and any combination thereof.

Exemplary whole fruits and whole vegetable sources of sugar include, but are not limited to, root vegetables in any form (whole, skinned, raw, cooked, roasted, frozen (including IQF), steamed, sautéed, baked, boiled, chopped, ground, pulverized, pureed, or their juice (excluding sugar sources from concentrated juices) such as beets of any color, carrots of any color, potatoes of any color, sweet potatoes of any color, or yams of any color; citrus fruit in any form (raw, segmented, sliced, chopped, pulverized, masticated, frozen (including IQF), pureed, cooked, boiled, steamed, roasted, or their juice) such as limes, lemons, oranges, mandarins and grapefruit; pome fruits in any form (whole, raw, dried, dehydrated, cooked, boiled, roasted, steamed, sautéed, baked, pureed, chopped, frozen (including IQF), blended, pulverized, or their juice) such as apples of any variety, pears of any variety, and Asian pears; stone fruits in any form (whole, raw, frozen (including IQF), dried, dehydrated, cooked, boiled, roasted, steamed, sautéed, baked, pureed, chopped, blended, pulverized, or their juice), such as peaches, nectarines, cherries, apricots and plums of any color; tropical fruits in any form (whole, raw, dried, dehydrated, frozen (including IQF), cooked, boiled, roasted, steamed, sautéed, baked, pureed, chopped, blended, masticated, pulverized, or their juice), such as mangos, papayas, pineapple, or banana; berries in any form (whole, raw, dried, dehydrated, frozen (including IQF), cooked, boiled, roasted, steamed, sautéed, baked, pureed, chopped, blended, pulverized, or their juice), such as strawberries, raspberries, blackberries, mulberries and blueberries, melons in any form (whole, raw, dried, dehydrated, frozen (including IQF), cooked, boiled, roasted, steamed, sautéed, baked, pureed, chopped, blended, pulverized or their juice), such as cantaloupe, watermelon and honeydew, squash in any form (whole, raw, dried, dehydrated, frozen (including IQF), cooked, boiled, roasted, steamed, sautéed, baked, pureed, chopped, blended, or pulverized), such as acorn squash, yellow squash, zucchini, summer squash, pumpkin, and butternut squash; and any combination thereof.

The food products described herein may further include natural omega-3-fatty acid, for example about 0.5-2 grams (e.g., about 0.5, 0.6, 0.7, 0.8, 0.9, 1, 1.1, 1.2, 1.3, 1.4, 1.5, 1.6, 1.7, 1.8, 1.9, 2 g or about 1-2, 0.5-1 g) in each serving of the food products.

Exemplary sources of natural omega-3-fatty acid include, but are not limited to, seeds in any form (whole, raw, sprouted, hydrated, dried, cooked, roasted, boiled, steamed, toasted, ground, chopped, frozen (including IQF), pulverized, or their oil), such as flax, sunflower, pumpkin, perilla, psyillium (including husks), sesame, hemp and chia seeds; and legumes in any form (dried, raw, cooked, roasted, hydrated, frozen (including IQF), boiled, toasted, steamed, split, chopped, ground, pulverized or pureed), such as lentils of any color, beans (such as lima beans, kidney beans, navy beans or white beans) chickpeas, and peas of any color; leafy vegetables in any form (whole, raw, cooked, boiled, roasted, frozen (including IQF), steamed, sautéed, baked, pureed, chopped, blended or pulverized) such as kale, spinach, collard greens, lettuce of all varieties, and beet greens.

The food products described herein may further include natural folate, for example about 20-200 micrograms (e.g., about 20, 30, 40, 50, 60, 70, 80, 90, 100, 110, 120, 130, 140, 150, 160, 170, 180, 190, 200 μg or about 20-100, 50-100, 100-150, 100-200, 150-200 μg) of natural folate from legumes such as lentils, root vegetables such as beets, leafy greens, such as spinach, cruciferous vegetables such as broccoli and cauliflower, other vegetables such as green beans and corn, and herbs such as mint; in each serving of the food products.

The food products described herein may further include one or more natural supplemental vitamins and/or minerals.

Exemplary sources for the one or more supplemental vitamins and minerals include, but are not limited to, folate source (e.g., Vitamin B-9) from legumes such as lentils, root vegetables such as beets, leafy greens, such as spinach, cruciferous vegetables such as broccoli, cauliflower, and Brussels sprouts, other vegetables such as green beans, asparagus and corn, and herbs such as mint; Vitamin C source from root vegetables, such as leafy greens such as spinach and kale, cruciferous vegetables such as broccoli and cauliflower, other vegetables such as green beans and corn, citrus (whole fruit and citrus juice) such as lemon, orange, and lime, and fruit (or the juices from fruit), such as cantaloupe, pineapple, and mango; Vitamin A source from root vegetables such as sweet potatoes and carrots, leafy greens, such as spinach and kale, citrus such as mandarin orange, fruit such as cantaloupe and mango, and herbs such as mint; Vitamin K source from leafy greens such as kale and spinach, cruciferous vegetables such as broccoli, Cauliflower and Brussel sprouts, and other vegetables such as green beans; Choline source from root vegetables such as sweet potatoes, yams and carrots, leafy greens such as spinach and kale, herbs such as mint, and roots such as ginger; Vitamin B6 source from root vegetables, such as sweet potatoes, yams and carrots, leafy greens such as spinach and kale, cruciferous vegetables such as cauliflower, and fruit such as bananas; Calcium source from leafy greens such as kale and spinach, seeds, such as chia, and herbs such as mint; Iron source from legumes such as lentils, grains such as quinoa, leafy greens such as spinach and kale, herbs such as mint; Potassium from root vegetables such as sweet potato, yams and beets, leafy greens such as spinach and kale, herbs such as mint, fruit such as banana, and melon, and nuts, such as coconut (or coconut water); Magnesium source from legumes such as lentils, grains such as quinoa, leafy greens such as spinach and kale, fruit such as bananas, roots such as ginger, and herbs such as mint; Manganese source from legumes such as lentils, seeds such as chia, leafy greens such as spinach, tropical fruits such as pineapple, and herbs such as mint; Selenium source from legumes such as lentils, grains such as quinoa, leafy greens such as kale and spinach, and fruit such as bananas; Zinc source from legumes such as lentils, grains such as quinoa, root vegetables such as carrots, leafy greens such as kale and spinach, and seeds such as chia; Niacin source from legumes such as lentils, root vegetables such as carrots, leafy greens such as kale, and herbs such as mint; Phosphorus source from legumes such as lentils, grains such as quinoa, and seeds such as chia; Pantothenic Acid source from legumes such as lentils, and root vegetables such as sweet potatoes; Riboflavin source from leafy greens such as spinach; Thiamin source from legumes such as lentils, and leafy greens such as kale; and a Betaine source from root vegetables such as beets, and leafy greens such as spinach.

In some embodiments, the food products described herein include, in each serving size one or more natural supplemental vitamins and/or minerals obtained from about 50 to about 400 micrograms (e.g., about 50, 75, 100, 125, 150, 175, 200, 225, 250, 275, 300, 325, 350, 375, 400 μg or about 100-400, 150-400, 200-400, 50-300, 100-300 μg) folate source (e.g., Vitamin B-9); from about 20 to about 300 milligrams (e.g., about 20, 30, 40, 50, 75, 100, 125, 150, 175, 200, 225, 250, 275, 300 mg or about 20-250, 30-250, 40-300 mg) of a Vitamin C source; from about 2,000 to about 12,000 IU (e.g., about 2000, 2500, 3000, 3500, 4000, 4500, 5000, 5500, 6000, 6500, 7000, 7500, 8000, 8500, 9000, 9500, 10000, 10500, 11000, 11500, 12000 IU or about 2000-10000, 4000-10000, 5000-12000 IU) of a Vitamin A source; from about 0.1 to about 300 micrograms (e.g., about 0.1, 0.5, 1, 1.5, 2, 2.5, 3, 3.5, 4, 4.5, 5, 5.5, 6, 6.5, 7, 7.5, 8, 8.5, 9, 9.5, 10, 20, 30, 40, 50, 60, 70, 80, 90, 100, 110, 120, 130, 140, 150, 160, 170, 180, 190, 200, 25, 300 μg or about 0.1-10, 10-300, 10-200, 50-200 μg) of a Vitamin K source; from about 10 to about 40 milligrams (e.g., about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 mg or about 10-30, 20-40, 30-40 mg) of a Choline source; from about 350 to about 500 micrograms (e.g., about 350, 375, 400, 425, 450, 475, 500 μg or about 350-450, 450-500 μg) of a Vitamin B6 source; from about 100 to about 500 milligrams (e.g., about 100, 125, 150, 175, 200, 225, 250, 275, 300, 325, 350, 375, 400, 425, 450, 475, 500 mg or about 100-400, 200-500, 100-300, 200-300 mg) Calcium; 2-10 milligrams (e.g., about 2, 3, 4, 5, 6, 7, 8, 9, 10 mg or about 2-9, 3-9, 5-9, 5-10 mg) Iron; 500-3,000 milligrams (e.g., about 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000 mg or about 500-2500, 500-2000, 1000-3000 mg) Potassium; 50-300 milligrams (e.g., about 50, 75, 100, 125, 150, 175, 200, 225, 250, 275, 300 mg or about 50-250, 100-300, 100-250 mg) of a Magnesium source; from about 0.5 to about 2.5 mg (e.g., about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5 mg or about 0.5-2, 1-2.5, 1-2 mg) of a Manganese source; from about 0.2 to about 1 mg (e.g., about 0.2, 0.3, 0.4, 0.5, 0.6, 0.7, 0.8, 0.9, or 1 mg or about 0.2-0.5, 0.2-0.9, 0.5-1 mg) of a Selenium source; from about 1 to about 8 mg (e.g., about 1, 2, 3, 4, 5, 6, 7, 8 mg or about 1-7, 2-8, 3-6 mg) of a Zinc source; from about 1 to about 15 mg (e.g., about 1, 2, 3, 4, 5, 6, 7, 8, 9, 10, 11, 12, 13, 14, 15 mg or about 1-10, 5-15, 5-10 mg) of a Niacin source; from about 200 to about 700 mg (e.g., about 200, 225, 250, 275, 300, 325, 350, 375, 400, 425, 450, 475, 500, 525, 550, 575, 600, 625, 650, 675, 700 mg or about 200-600, 400-700, 400-600 mg) of a Phosphorus source; from about 0.1 to 2 mg (e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2 mg or about 0.1-1.5, 0.5-2, 1-2 mg) of a Pantothenic Acid source; from about 0.1 to 2 mg (e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2 mg or 0.1-1.5, 0.5-2, 1-2 mg) of a Riboflavin source; from about 0.1 to about 1 mg (e.g., about 0.1, 0.2, 0.3, 0.4, 0.5, 0.6, 0.7, 0.8, 0.9, 1 mg or about 0.1-0.5, 0.5-1 mg) of a Thiamin source; and/or about 5 to about 150 mg (e.g., about 5, 10, 20, 30, 40, 50, 60, 70, 80, 90, 100, 110, 120, 130, 140, 150 mg or 10-150, 5-100, 50-100 mg) of a Betaine source.

In some embodiments, the food products described herein may include, in each serving size, about 2 to about 10 grams (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9 grams) of a protein from a whole food source; from about 3 to about 20 grams (e.g., about 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.5, 11, 11.5, 12, 12.5, 13, 13.5, 14, 14.5, 15, 15.5, 16, 16.5, 17, 17.5, 18, 18.5, 19, 19.5, 20 grams) fiber source; from about 2 to about 15 grams (e.g., about 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.5, 11, 11.5, 12, 12.5, 13, 13.5, 14, 14.5, 15 grams of sugar (from whole fruits and vegetables); from about 0.6 to about 2 grams (e.g., about 0.6, 0.7, 0.8, 0.9, 1, 1.1, 1.2, 1.3, 1.4, 1.5, 1.6, 1.7, 1.8, 1.9, 2 grams) omega-3-fatty acid; from about 20 to about 200 micrograms (e.g., about 20, 30, 40, 50, 60, 70, 80, 90, 100, 110, 120, 130, 140, 150, 160, 170, 180, 190, 200 μg) folate (e.g., Vitamin B-9); from about 5 to about 100 milligrams (e.g., about 5, 10, 20, 30, 40, 50, 60, 70, 80, 90, 100 mg) Vitamin C; from about 2,000 to about 6,000 IU (e.g., about 2000, 2500, 3000, 3500, 4000, 4500, 5000, 5500, 6000 IU) Vitamin A; from about 1 to about 150 micrograms (e.g., about 1, 5, 10, 20, 30, 40, 50, 60, 70, 80, 90, 100, 110, 120, 130, 140, 150 μg) Vitamin K; from about 5 to about 20 milligrams (e.g., about 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 1.5, 19, 19.5, 20 mg) Choline; from about 0.01 to about 0.3 milligrams (e.g., about 0.01, 0.05, 0.1, 0.15, 0.2, 0.25, 0.3 mg) Vitamin B6; from about 50 to about 200 milligrams (e.g., about 50, 75, 100, 125, 150, 175, 200 mg) Calcium; from about 0.1 to about 2 milligrams (e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2 mg) Iron; from about 200 to about 1,500 milligrams (e.g., about 200, 300, 400, 500, 600, 700, 800, 900, 1000, 1100, 1200, 1300, 1400, 1500 mg) Potassium; from about 10 to about 100 milligrams (e.g., about 10, 20, 30, 40, 50, 60, 70, 80, 90, 100 mg) Magnesium; from about 0.5 to about 2.5 milligrams (e.g., 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5 mg) Manganese; from about 0.2 to about 1.5 mg (e.g., about 0.2, 0.3, 0.4, 0.5, 0.6, 0.7, 0.8, 0.9, 1, 1.1, 1.2, 1.3, 1.4, 1.5 mg) Selenium; from about 0.2 to about 2 milligrams (e.g., about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2 mg) Zinc; from about 0.1 to about 1.5 milligrams (e.g., about 0.1, 0.2, 0.3, 0.4, 0.5, 0.6, 0.7, 0.8, 0.9, 1, 1.1, 1.2, 1.3, 1.4, 1.5 mg) Niacin; from about 100 to about 400 milligrams (e.g., about 100, 125, 150, 175, 200, 225, 250, 275, 300, 325, 350, 375, 400 mg) Phosphorus; from about 0.05 to 1 milligrams (e.g., about 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1 mg) Pantothenic Acid; from about 0.5 to 1.5 milligrams (e.g., about 0.5, 0.6, 0.7, 0.8, 0.9, 1, 1.1, 1.2, 1.3, 1.4, 1.5 mg) Riboflavin; from about 0.05 to about 1 milligrams (e.g., about 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1 mg) Thiamin; and from about 5 to about 80 milligrams (e.g., about 5, 10, 20, 30, 40, 50, 60, 70, 80 mg) Betaine.

Components of fiber, protein, sugar and other nutrients can be contributed from a single whole food source or a combination of whole food sources in an additive way. For instance, the fiber can come from a combination of sources such as whole grains and legumes, and the protein component can also come from a combination of the same sources. As an example, half cup of quinoa might provide 1.5 grams of fiber and 2.5 grams of protein. Half cup of lentils might provide 4.5 grams of fiber and 5 grams of protein. The resulting total would be 6 grams of fiber and 7.5 grams of protein from a combination of these two sources. As another example, 1 cup (7 oz) cooked Lentils has 10 g protein and 9 g fiber; 1 cup (6.5 oz) cooked Quinoa has 5 g protein and 3 g fiber; 1 oz chia seeds has 17.6 g protein and 42 g fiber; 1 cup (4.7 oz) sweet potato has 1.8 g protein, 3.4 g fiber, and 4.8 g sugar. If adding a root vegetable to this combination, it would provide yet additional fiber, as well as sugar to the resulting combination.

Exemplary combinations for fiber and protein sources include whole grains, legumes, root vegetables, seeds and nuts, such as quinoa, lentils, beets, and chia seeds. Generally the total fiber is the result of a combination of 2-6 of the above food categories, but it can also be the result of a single source, such as seeds or nuts.

Similarly, the sugar component can come from one or multiple whole food sources, generally root vegetables, fruit, and the (unconcentrated) juices from root vegetables and fruits. Preferred combinations of food sources for total sugar are root vegetables, citrus fruits, pome fruits and fruit juice, such as beets, oranges, pear, and apple juice.

Exemplary combinations of whole food sources for the food products include, but are not limited to, 1) sweet potato, yam, chia, lentils, quinoa, beet, carrot and pear; 2) spinach, kale, sweet potato, yam, chia, lentils, quinoa and orange; 3) beet, spinach, pear, sweet potato, yam, chia, lentils, quinoa; and 4) orange, beet, sweet potato, yam, chia, lentils, quinoa banana.

In some embodiments, the food products described herein contain a core base that includes cooked lentils, cooked quinoa, yams, sweet potatoes, orange juice, banana, carrot juice, lemon juice, grape juice, vegetable broth, and water.

For example, the core base may include the whole foods listed in Table 1 below.

TABLE 1
Exemplary Ingredients of Core Base

| Ingredient | % weight |
|---|---|
| Cooked Lentils | about 5-25% (e.g., about 5, 6, 7, 8, 9, 10, 11, 12, |
| | 13, 14, 15, 16, 17, 18, 19, 20, 21, 22, 23, 24, |
| | 25%) |
| Cooked Quinoa | about 5-25% (e.g., about 5, 6, 7, 8, 9, 10, 11, 12, |
| | 13, 14, 15, 16, 17, 18, 19, 20, 21, 22, 23, 24, |
| | 25%) |
| Yams | about 3-15% (e.g., about 3, 4, 5, 6, 7, 8, 9, 10, |
| | 11, 12, 13, 14, 15%) |
| Sweet Potatoes | about 5-25% (e.g., about 5, 6, 7, 8, 9, 10, 11, 12, |
| | 13, 14, 15, 16, 17, 18, 19, 20, 21, 22, 23, 24, |
| | 25%) |
| Orange Juice | about 3-15% (e.g., about 3, 4, 5, 6, 7, 8, 9, 10, |
| | 11, 12, 13, 14, 15%) |
| Grape Juice | about 3-20% (e.g., 3, 4, 5, 6, 7, 8, 9, 10, 11, 12, |
| | 13, 14, 15, 16, 17, 18, 19, 20%) |
| Banana | about 3-10% (e.g., about 3, 4, 5, 6, 7, 8, 9, 10%) |
| Carrot Juice | about 10-30% (e.g., about 10, 12.5, 15, 17.5, |
| | 20, 22.5, 25, 27.5, 30%) |
| Distilled Water | about 3-50% (e.g., about 3, 5, 7.5, 10, 12.5, 15, |
| | 17.5, 20, 22.5, 25, 27.5, 30, 32.5, 35, 37.6, 40., |
| | 42.5, 45, 47.5, 50%) |
| Lemon Juice | about 2-15% (e.g., about 2, 3, 4, 5, 6, 7, 8, 9, 10, |
| | 11, 12, 13, 14, 15%) |
| Vegetable Broth | about 10-50% (e.g., about 10, 12.5, 15, 17.5, |
| | 20, 22.5, 25, 27.5, 30, 32.5, 35, 37.6, 40., 42.5, |
| | 45, 47.5, 50%) |
| Total weight | 100% |

In some embodiments, the food products described herein contain the core base and red beet, orange, lime juice, ginger, mint leaves and chia seeds.

For example, the food products may include the whole foods listed in Table 2 below.

TABLE 2
Exemplary Ingredients of Food Product A

| Ingredient | % Weight |
|---|---|
| Core base | about 40-70% (e.g., about 40, 47.5, 45, 50, 52.5, 55, 57.5, 60, |
| | 62.5, 65, 67.5, 70%) |
| Red Beet | about 5-20% (e.g., about 5, 6, 7, 8, 9, 10, 11, 12, 13, 14, 15, |
| | 16, 17, 18, 19, 20%) |
| Orange | about 0-15% (e.g., about 0.1, 0.5, 1, 2, 3, 4, 5, 6, 7, 8, 9, 10, |
| | 11, 12, 13, 14, 15%) |
| Lime | about 1-10% (e.g., about 1, 2, 3, 4, 5, 6, 7, 8, 9, 10%) |
| Juice | |
| Ginger | about 0-5% (e.g., about 0.1, 0.5, 1, 2, 3, 4, 5%) |
| Mint | about 1-10% (e.g., about 1, 2, 3, 4, 5, 6, 7, 8, 9, 10%) |
| Leaves | |
| Chia | about 1-12% (e.g., about 1, 2, 3, 4, 5, 6, 7, 8, 9, 10, 11, 12%) |
| Seeds | |
| Total | 100% |

In some embodiments, the food products described herein contain the core base and yellow beets, sweet potato, carrot, pear, mango, and chia seeds.

For example, the food products may include vegetable broth, carrot juice, yellow beet, sweet potato, lentils, chia seeds, carrot, mango, quinoa, lemon juice, pear, orange, banana, yams, and water.

For example, the food products may include the whole foods listed in Table 3 below.

TABLE 3
Exemplary Ingredients of Food Product B

| Ingredient | % Weight |
|---|---|
| Core base | about 40-70% (e.g., about 40, 47.5, 45, 50, 52.5, 55, 57.5, |
| | 60, 62.5, 65, 67.5, 70%) |
| Yellow | about 5-20% (e.g., about 5, 6, 7, 8, 9, 10, 11, 12, 13, 14, |
| Beets | 15, 16, 17, 18, 19, 20%) |
| Sweet | about 5-20% (e.g., about 5, 6, 7, 8, 9, 10, 11, 12, 13, 14, |
| Potato | 15, 16, 17, 18, 19, 20%) |
| Carrot | about 0-10% (e.g., about 0.1, 0.5, 1, 2, 3, 4, 5, 6, 7, 8, 9, |
| | 10%) |
| Pear | about 0-10% (e.g., about 0.1, 0.5, 1, 2, 3, 4, 5, 6, 7, 8, 9, |
| | 10%) |
| Mango | about 0-10% (e.g., about 0.1, 0.5, 1, 2, 3, 4, 5, 6, 7, 8, 9, |
| | 10%) |
| Chia | about 1-12% (e.g., about 1, 2, 3, 4, 5, 6, 7, 8, 9, 10, 11, |
| Seeds | 12%) |
| Total | 100% |

In some embodiments, the food products described herein contain the core base and kale, spinach, carrot, orange, pear, lemon juice and chia seeds.

For example, the food products may include vegetable broth, spinach, carrot juice, pear, lentils, chia seeds, orange, kale, lemon juice, quinoa, carrot, sweet potato, banana, yams, and water.

For example, the food products may include the whole foods listed in Table 4 below.

TABLE 4
Exemplary Ingredients of Food Product C

| Ingredient | % Weight |
|---|---|
| Core base | about 40-70% (e.g., about 40, 47.5, 45, 50, 52.5, 55, 57.5, |
| | 60, 62.5, 65, 67.5, 70%) |
| Kale | about 1-15% (e.g., about 1, 2, 3, 4, 5, 6, 7, 8, 9, 10, 11, 12, |
| | 13, 14, 15%) |
| Spinach | about 1-15% (e.g., about 1, 2, 3, 4, 5, 6, 7, 8, 9, 10, 11, 12, |
| | 13, 14, 15%) |
| Carrot | about 1-15%(e.g., about 1, 2, 3, 4, 5, 6, 7, 8, 9, 10, 11, 12, |
| | 13, 14, 15%) |
| Orange | about 1-15% (e.g., about 1, 2, 3, 4, 5, 6, 7, 8, 9, 10, 11, 12, |
| | 13, 14, 15%) |
| Pear | about 1-15% (e.g., about 1, 2, 3, 4, 5, 6, 7, 8, 9, 10, 11, 12, |
| | 13, 14, 15%) |
| Lemon | about 0-10% (e.g., about 0.1, 0.5, 1, 2, 3, 4, 5, 6, 7, 8, 9, |
| Juice | 10%) |
| Chia | about 1-12% (e.g., about 1, 2, 3, 4, 5, 6, 7, 8, 9, 10, 11, 12%) |
| Seeds | |
| Total | 100% |

In some embodiments, the food products described herein contain the core base and red beet, pear, spinach, lemon juice, reduced balsamic vinegar, and chia seeds.

For example, the food products may include vegetable broth, beet, spinach, pear, carrot juice, chia seeds, lentils, grapes, quinoa, sweet potatoes, orange, banana, yams, lemon juice, balsamic vinegar, and water.

For example, the food products may include the whole foods listed in Table 5 below.

TABLE 5
Exemplary Ingredients of Food Product D

| Ingredient | % Weight |
|---|---|
| BNB | about 40-70% (e.g., about 40, 47.5, 45, 50, 52.5, 55, 57.5, |
| | 60, 62.5, 65, 67.5, 70%) |
| Red Beet | about 5-20% (e.g., about 5, 6, 7, 8, 9, 10, 11, 12, 13, 14, 15, |
| | 16, 17, 18, 19, 20%) |
| Pear | about 0-15% (e.g., about 0.1, 0.5, 1, 2, 3, 4, 5, 6, 7, 8, 9, 10, |
| | 11, 12, 13, 14, 15%) |
| Spinach | about 5-20% (e.g., about 5, 6, 7, 8, 9, 10, 11, 12, 13, 14, 15, |
| | 16, 17, 18, 19, 20%) |
| Lemon | about 1-11% (e.g., about 1, 2, 3, 4, 5, 6, 7, 8, 9, 10, 11%) |
| Juice | |
| Balsamic | about 0-5% (e.g., about 0.1, 0.5, 1, 2, 3, 4, 5%) |
| Vinegar | |
| Chia | about 1-12% (e.g., about 1, 2, 3, 4, 5, 6, 7, 8, 9, 10, 11, 12%) |
| Seeds | |
| Total | 100% |

In some embodiments, the food products contain vegetable broth, beet, orange, carrot juice, lentils, chia seeds, grape juice, quinoa, sweet potato, banana, yams, lime juice, lemon juice, mint leaves, ginger, and water.

In some embodiments, the food products described herein contain red beet, pear, spinach, reduced balsamic vinegar, apple juice, chia seeds, cooked lentils, cooked quinoa, yams, sweet potatoes, orange juice, banana, carrot juice, lemon juice, vegetable broth, sea salt, and water.

For example, the food products may include the ingredients listed in Table 6 below.

TABLE 6
Exemplary Ingredients of Food Product E

| Ingredient | % Weight |
|---|---|
| Red Beet | about 5-15% (e.g., about 5, 6, 7, 8, 9, 10, 11, 12, 13, 14, |
| | 15%) |
| Pear | about 1-10% (e.g., about 1, 2, 3, 4, 5, 6, 7, 8, 9, 10%) |
| Spinach | about 5-15% (e.g., about 5, 6, 7, 8, 9, 10, 11, 12, 13, 14, |
| | 15%) |
| Reduced | about 0-5% (e.g., about 0.1, 0.5, 1, 2, 3, 4, 5%) |
| Balsamic | |
| Vinegar | |
| Apple Juice | about 1-10% (e.g., about 1, 2, 3, 4, 5, 6, 7, 8, 9, 10%) |
| Chia Seeds | about 1-10% (e.g., about 1, 2, 3, 4, 5, 6, 7, 8, 9, 10%) |
| Cooked Lentils | about 1-10% (e.g., about 1, 2, 3, 4, 5, 6, 7, 8, 9, 10%) |
| Cooked Quinoa | about 1-10% (e.g., about 1, 2, 3, 4, 5, 6, 7, 8, 9, 10%) |
| Yams | about 1-5% (e.g., about 1, 2, 3, 4, 5%) |
| Sweet Potatoes | about 1-10% (e.g., about 1, 2, 3, 4, 5, 6, 7, 8, 9, 10%) |
| Orange Juice | about 1-10% (e.g., about 1, 2, 3, 4, 5, 6, 7, 8, 9, 10%) |
| Banana | about 1-10% (e.g., about 1, 2, 3, 4, 5, 6, 7, 8, 9, 10%) |
| Carrot Juice | about 5-15% (e.g., about 5, 6, 7, 8, 9, 10, 11, 12, 13, 14, |
| | 15%) |
| Water | about 1-10% (e.g., about 1, 2, 3, 4, 5, 6, 7, 8, 9, 10%) |
| Lemon Juice | about 5-15% (e.g., about 5, 6, 7, 8, 9, 10, 11, 12, 13, 14, |
| | 15%) |
| Vegetable | about 5-15% (e.g., about 5, 6, 7, 8, 9, 10, 11, 12, 13, 14, |
| Broth | 15%) |
| Sea Salt | about 0-5% (e.g., about 0.1, 0.5, 1, 2, 3, 4, 5%) |
| Total | about 100.00% |

In some embodiments, the food products include yellow beets, carrot, pear, apple juice, mango, chia seeds, cooked lentils, cooked quinoa, yams, sweet potatoes, orange juice, banana, carrot juice, lemon juice, vegetable broth, cinnamon, sea salt, and water.

For example, the food products may include the ingredients listed in Table 7 below.

TABLE 7
Exemplary Ingredients of Food Product F

| Ingredient | % Weight |
|---|---|
| Yellow Beets | about 5-15% (e.g., about 5, 6, 7, 8, 9, 10, 11, 12, 13, 14, |
| | 15%) |
| Carrot | about 5-15% (e.g., about 5, 6, 7, 8, 9, 10, 11, 12, 13, 14, |
| | 15%) |
| Pear | about 1-10% (e.g., about 1, 2, 3, 4, 5, 6, 7, 8, 9, 10%) |
| Apple Juice | about 1-10% (e.g., about 1, 2, 3, 4, 5, 6, 7, 8, 9, 10%) |
| Mango | about 1-10% (e.g., about 1, 2, 3, 4, 5, 6, 7, 8, 9, 10%) |
| Chia Seeds | about 1-10% (e.g., about 1, 2, 3, 4, 5, 6, 7, 8, 9, 10%) |
| Cooked Lentils | about 1-10% (e.g., about 1, 2, 3, 4, 5, 6, 7, 8, 9, 10%) |
| Cooked Quinoa | about 1-10% (e.g., about 1, 2, 3, 4, 5, 6, 7, 8, 9, 10%) |
| Yams | about 1-10% (e.g., about 1, 2, 3, 4, 5, 6, 7, 8, 9, 10%) |
| Sweet Potatoes | about 1-10% (e.g., about 1, 2, 3, 4, 5, 6, 7, 8, 9, 10%) |
| Orange Juice | about 1-10% (e.g., about 1, 2, 3, 4, 5, 6, 7, 8, 9, 10%) |
| Banana | about 1-10% (e.g., about 1, 2, 3, 4, 5, 6, 7, 8, 9, 10%) |
| Carrot Juice | about 1-10% (e.g., about 1, 2, 3, 4, 5, 6, 7, 8, 9, 10%) |
| Water | about 1-10% (e.g., about 1, 2, 3, 4, 5, 6, 7, 8, 9, 10%) |
| Lemon Juice | about 5-15% (e.g., about 5, 6, 7, 8, 9, 10, 11, 12, 13, 14, |
| | 15%) |
| Vegetable | about 5-15% (e.g., about 5, 6, 7, 8, 9, 10, 11, 12, 13, 14, |
| Broth | 15%) |
| Cinnamon | about 0-5% (e.g., about 0.1, 0.5, 1, 2, 3, 4, 5%) |
| Sea Salt | about 0-5% (e.g., about 0.1, 0.5, 1, 2, 3, 4, 5%) |
| Total | 100% |

In some embodiments, the food products include read beet, orange, lime juice, apple juice, ginger, fresh mint leaves, chia seeds, cooked lentils, cooked quinoa, yams, sweet potatoes, orange juice, banana, carrot juice, lemon juice, vegetable broth, sea salt and water.

For example, the food products may include the ingredients listed in Table 8 below.

TABLE 8
Exemplary Ingredients of Food Product G

| Ingredient | % Weight |
|---|---|
| Red Beet | about 5-15% (e.g., about 5, 6, 7, 8, 9, 10, 11, 12, 13, 14, 15%) |
| Orange | about 1-10% (e.g., about 1, 2, 3, 4, 5, 6, 7, 8, 9, 10%) |
| Lime Juice | about 1-10% (e.g., about 1, 2, 3, 4, 5, 6, 7, 8, 9, 10%) |
| Apple Juice | about 1-10% (e.g., about 1, 2, 3, 4, 5, 6, 7, 8, 9, 10%) |
| Ginger | about 0-5% (e.g., about 0.1, 0.5, 1, 2, 3, 4, 5%) |
| Fresh Mint Leaves | about 1-10% (e.g., about 1, 2, 3, 4, 5, 6, 7, 8, 9, 10%) |
| Chia Seeds | about 1-10% (e.g., about 1, 2, 3, 4, 5, 6, 7, 8, 9, 10%) |
| Cooked Lentils | about 1-10% (e.g., about 1, 2, 3, 4, 5, 6, 7, 8, 9, 10%) |
| Cooked Quinoa | about 1-10% (e.g., about 1, 2, 3, 4, 5, 6, 7, 8, 9, 10%) |
| Yams | about 1-10% (e.g., about 1, 2, 3, 4, 5, 6, 7, 8, 9, 10%) |
| Sweet Potatoes | about 1-10% (e.g., about 1, 2, 3, 4, 5, 6, 7, 8, 9, 10%) |
| Orange Juice | about 1-10% (e.g., about 1, 2, 3, 4, 5, 6, 7, 8, 9, 10%) |
| Banana | about 1-10% (e.g., about 1, 2, 3, 4, 5, 6, 7, 8, 9, 10%) |
| Carrot Juice | about 5-15% (e.g., about 5, 6, 7, 8, 9, 10, 11, 12, 13, 14, 15%) |
| Water | about 1-15% (e.g., about 1, 2, 3, 4, 5, 6, 7, 8, 9, 10, 11, 12, 13, |
| | 14, 15%) |
| Lemon Juice | about 1-10% (e.g., about 1, 2, 3, 4, 5, 6, 7, 8, 9, 10%) |
| Vegetable Broth | about 5-15% (e.g., about 5, 6, 7, 8, 9, 10, 11, 12, 13, 14, 15%) |
| Sea Salt | about 0-5% (e.g., about 0.1, 0.5, 1, 2, 3, 4, 5%) |
| Total | 100% |

In some embodiments, the food products, in each serving, contain the following nutritional profile:

| | | % DV |
|---|---|---|
| Ingredient | Amount | (daily value) |
| Calories | 94.9 | |
| Fat g | 2.5 | 4% |
| Carbs g | 16.5 | 5% |
| Sugars g | 5.6 | |
| Protein g | 3.1 | 6% |
| Fiber g | 5.2 | 21% |
| Starch g | 1.9 | |
| Cholesterol | 0.0 | 0% |
| Sodium mg | 45.2 | 2% |
| Vit C mg | 12.2 | 20% |
| Vit A IU | 2782.3 | 56% |
| Vit D3 IU | 0.0 | 0% |
| Vit K mcg | 3.2 | 4% |
| Vit E mg | 0.3 | 1% |
| B-6 mg | 0.1 | 6% |
| B-12 mcg | 0.0 | 0% |
| Folate (B9) mcg | 43.2 | 11% |
| Ca mg | 68.1 | 7% |
| Iron mg | 0.9 | 5% |
| Omega-3 mg | 1267.4 | |
| Omega-6 mg | 457.2 | |
| Potasium mg | 270.6 | 8% |
| Magnesium mg | 20.1 | 5% |
| Manganese mg | 0.4 | 19% |
| Selenium mcg | 0.7 | 1% |
| Zinc mg | 0.8 | 5% |
| Niacin mg | 0.4 | 2% |
| Copper mg | 0.1 | 6% |
| Phosphorus mg | 115.9 | 12% |
| Choline mg | 6.5 | 0% |
| Pantothenic acid mg | 0.2 | 2% |
| Thiamin mg | 0.1 | 4% |
| Riboflavin mg | 0.1 | 3% |
| Betaine mg | 18.6 | |
| Phytosterols mg | 13.3 | |

In some embodiments, the food products, in each serving, contain the following nutritional profile:

| Ingredient | Amount | % DV |
|---|---|---|
| Calories | 93.6 | |
| Fat g | 2.4 | 4% |
| Carbs g | 16.2 | 5% |
| Sugars g | 5.6 | |
| Protein g | 2.9 | 6% |
| Fiber g | 5.0 | 20% |
| Starch g | 2.5 | |
| Cholesterol | 0.0 | 0% |
| Sodium mg | 50.7 | 2% |
| Vit C mg | 10.0 | 17% |
| Vit A IU | 4414.8 | 88% |
| Vit D3 IU | 0.0 | 0% |
| Vit K mcg | 4.3 | 5% |
| Vit E mg | 0.4 | 1% |
| B-6 mg | 0.1 | 6% |
| B-12 mcg | 0.0 | 0% |
| Folate (B9) mcg | 37.1 | 9% |
| Ca mg | 61.4 | 6% |
| Iron mg | 0.6 | 3% |
| Omega-3 mg | 1253.1 | |
| Omega-6 mg | 452.6 | |
| Potassium mg | 257.4 | 7% |
| Magnesium mg | 17.7 | 4% |
| Manganese mg | 0.3 | 17% |
| Selenium mcg | 0.7 | 1% |
| Zinc mg | 0.7 | 5% |
| Niacin mg | 0.4 | 2% |
| Copper mg | 0.1 | 6% |
| Phosphorus mg | 113.0 | 11% |
| Choline mg | 8.8 | 0% |
| Pantothenic acid mg | 0.2 | 2% |
| Thiamin mg | 0.1 | 4% |
| Riboflavin mg | 0.1 | 3% |
| Betaine mg | 15.4 | |
| Phytosterols mg | 10.9 | |

In some embodiments, the food products, in each serving, contain the following nutritional profile:

| Ingredient | Amount | % DV |
|---|---|---|
| Calories | 91.6 | |
| Fat g | 2.5 | 4% |
| Carbs g | 15.4 | 5% |
| Sugars g | 4.9 | |
| Protein g | 3.2 | 6% |
| Fiber g | 5.1 | 20% |
| Starch g | 1.6 | |
| Cholesterol | 0.0 | 0% |
| Sodium mg | 48.1 | 2% |
| Vit C mg | 20.9 | 35% |
| Vit A IU | 5088.5 | 102% |
| Vit D3 IU | 0.0 | 0% |
| Vit K mcg | 109.2 | 136% |
| Vit E mg | 0.5 | 2% |
| B-6 mg | 0.2 | 8% |
| B-12 mcg | 0.0 | 0% |
| Folate (B9) mcg | 46.7 | 12% |
| Ca mg | 117.1 | 12% |
| Iron mg | 0.9 | 5% |
| Omega-3 mg | 1329.1 | |
| Omega-6 mg | 473.3 | |
| Potassium mg | 285.3 | 8% |
| Magnesium mg | 24.1 | 6% |
| Manganese mg | 0.5 | 23% |
| Selenium mcg | 0.8 | 1% |
| Zinc mg | 0.8 | 5% |
| Niacin mg | 0.5 | 2% |
| Copper mg | 0.1 | 6% |
| Phosphorus mg | 116.2 | 12% |
| Choline mg | 6.7 | 0% |
| Pantothenic acid mg | 0.2 | 2% |
| Thiamin mg | 0.1 | 4% |
| Riboflavin mg | 0.1 | 5% |
| Betaine mg | 61.7 | |
| Phytosterols mg | 13.5 | |

In some embodiments, the food products, in each serving, contain the following nutritional profile:

| Ingredient | Amount | % DV |
|---|---|---|
| Calories | 89.6 | |
| Fat g | 2.4 | 4% |
| Carbs g | 15.1 | 5% |
| Sugars g | 5.3 | |
| Protein g | 3.1 | 6% |
| Fiber g | 5.1 | 20% |
| Starch g | 1.6 | |
| Cholesterol | 0.0 | 0% |
| Sodium mg | 55.2 | 2% |
| Vit C mg | 11.8 | 20% |
| Vit A IU | 3468.1 | 69% |
| Vit D3 IU | 0.0 | 0% |
| Vit K mcg | 72.3 | 90% |
| Vit E mg | 0.5 | 2% |
| B-6 mg | 0.1 | 7% |
| B-12 mcg | 0.0 | 0% |
| Folate (B9) mcg | 62.8 | 16% |
| Ca mg | 119.8 | 12% |
| Iron mg | 0.9 | 5% |
| Omega-3 mg | 1269.9 | |
| Omega-6 mg | 448.1 | |
| Potassium mg | 294.8 | 8% |
| Magnesium mg | 26.4 | 7% |
| Manganese mg | 0.5 | 23% |
| Selenium mcg | 0.7 | 1% |
| Zinc mg | 0.7 | 5% |
| Niacin mg | 0.4 | 2% |
| Copper mg | 0.1 | 5% |
| Phosphorus mg | 112.2 | 11% |
| Choline mg | 9.5 | 0% |
| Pantothenic acid mg | 0.2 | 2% |
| Thiamin mg | 0.0 | 3% |
| Riboflavin mg | 0.1 | 5% |
| Betaine mg | 97.4 | |
| Phytosterols mg | 13.1 | |

In some embodiments, the food products, in each serving, contain the following nutritional profile:

| Ingredient | Amount | % DV |
|---|---|---|
| Calories | 90 | |
| Fat g | 2.5 | 4% |
| Carbs g | 15 | 5% |
| Sugars g | 5 | |
| Protein g | 3 | 6% |
| Fiber g | 5 | 20% |
| Starch g | 2 | |
| Cholesterol | 0 | 0% |
| Sodium mg | 92 | 4% |
| Vit C mg | 14 | 23% |
| Vit A IU | 3732 | 75% |
| Vit D3 IU | 0 | 0% |
| Vit K mcg | 52 | 65% |
| Vit E mg | 0.4 | 1% |
| B-6 mg | 0.1 | 7% |
| B-12 mcg | 0 | 0% |
| Folate (B9) mcg | 50 | 13% |
| Ca mg | 104 | 10% |
| Iron mg | 1 | 5% |
| Omega-3 mg | 1281 | |
| Omega-6 mg | 454 | |
| Potassium mg | 259 | 7% |
| Magnesium mg | 24 | 6% |
| Manganese mg | 0.4 | 21% |
| Selenium mcg | 1 | 1% |
| Zinc mg | 1 | 5% |
| Niacin mg | 0.3 | 2% |
| Copper mg | 0.1 | 5% |
| Phosphorus mg | 111 | 11% |
| Choline mg | 8 | 0% |
| Pantothenic acid mg | 0.2 | 2% |
| Thiamin mg | 0.1 | 4% |
| Riboflavin mg | 0.1 | 4% |
| Betaine mg | 72 | |
| Phytosterols mg | 6 | |

In some embodiments, the food products, in each serving, contain the following nutritional profile:

| Ingredient | Amount | % DV |
|---|---|---|
| Calories | 90 | |
| Fat g | 2.6 | 4% |
| Carbs g | 15 | 5% |
| Sugars g | 5 | |
| Protein g | 3 | 6% |
| Fiber g | 5 | 20% |
| Starch g | 3 | |
| Cholesterol | 0 | 0% |
| Sodium mg | 81 | 3% |
| Vit C mg | 9 | 15% |
| Vit A IU | 3655 | 73% |
| Vit D3 IU | 0 | 0% |
| Vit K mcg | 3 | 4% |
| Vit E mg | 0.3 | 1% |
| B-6 mg | 0.1 | 5% |
| B-12 mcg | 0 | 0% |
| Folate (B9) mcg | 33 | 8% |
| Ca mg | 65 | 7% |
| Iron mg | 1 | 3% |
| Omega-3 mg | 1327 | |
| Omega-6 mg | 478 | |
| Potassium mg | 228 | 7% |
| Magnesium mg | 17 | 4% |
| Manganese mg | 0.4 | 19% |
| Selenium mcg | 1 | 1% |
| Zinc mg | 1 | 4% |
| Niacin mg | 0.4 | 2% |
| Copper mg | 0.1 | 5% |
| Phosphorus mg | 112 | 11% |
| Choline mg | 7 | 0% |
| Pantothenic acid mg | 0.2 | 2% |
| Thiamin mg | 0.1 | 4% |
| Riboflavin mg | 0.0 | 3% |
| Betaine mg | 15 | |
| Phytosterols mg | 5 | |

In some embodiments, the food products, in each serving, contain the following nutritional profile:

| Ingredient | Amount | % DV |
|---|---|---|
| Calories | 90 | |
| Fat g | 2.6 | 4% |
| Carbs g | 15 | 5% |
| Sugars g | 4 | |
| Protein g | 3 | 6% |
| Fiber g | 5 | 20% |
| Starch g | 2 | |
| Cholesterol | 0 | 0% |
| Sodium mg | 86 | 4% |
| Vit C mg | 21 | 35% |
| Vit A IU | 4855 | 97% |
| Vit D3 IU | 0 | 0% |
| Vit K mcg | 103 | 129% |
| Vit E mg | 1 | 2% |
| B-6 mg | 0.2 | 8% |
| B-12 mcg | 0 | 0% |
| Folate (B9) mcg | 45 | 11% |
| Ca mg | 122 | 12% |
| Iron mg | 1 | 6% |
| Omega-3 mg | 1313 | |
| Omega-6 mg | 471 | |
| Potassium mg | 276 | 8% |
| Magnesium mg | 26 | 7% |
| Manganese mg | 0.5 | 23% |
| Selenium mcg | 0.8 | 1% |
| Zinc mg | 0.8 | 5% |
| Niacin mg | 0.4 | 2% |
| Copper mg | 0.1 | 6% |
| Phosphorus mg | 115.1 | 12% |
| Choline mg | 7.1 | 0% |
| Pantothenic acid mg | 0.2 | 2% |
| Thiamin mg | 0.1 | 4% |
| Riboflavin mg | 0.1 | 5% |
| Betaine mg | 65.5 | |
| Phytosterols mg | 17.8 | |

In some embodiments, the food products, in each serving, contain the following nutritional profile:

| Ingredient | Amount | % DV |
|---|---|---|
| Calories | 90 | |
| Fat g | 2.5 | 4% |
| Carbs g | 15 | 5% |
| Sugars g | 4 | |
| Protein g | 3 | 6% |
| Fiber g | 5 | 20% |
| Starch g | 2 | |
| Cholesterol | 0 | 0% |
| Sodium mg | 89 | 4% |
| Vit C mg | 13 | 22% |
| Vit A IU | 3168 | 63% |
| Vit D3 IU | 0 | 0% |
| Vit K mcg | 2 | 3% |
| Vit E mg | 0.2 | 1% |
| B-6 mg | 0.1 | 6% |
| B-12 mcg | 0 | 0% |
| Folate (B9) mcg | 38 | 9% |
| Ca mg | 70 | 7% |
| Iron mg | 1 | 5% |
| Omega-3 mg | 1295 | |
| Omega-6 mg | 462 | |
| Potassium mg | 248 | 7% |
| Magnesium mg | 19 | 5% |
| Manganese mg | 0.4 | 18% |
| Selenium mcg | 1 | 1% |
| Zinc mg | 1 | 5% |
| Niacin mg | 0.4 | 2% |
| Copper mg | 0.1 | 6% |
| Phosphorus mg | 112 | 11% |
| Choline mg | 5 | 0% |
| Pantothenic acid mg | 0.2 | 2% |
| Thiamin mg | 0.1 | 4% |
| Riboflavin mg | 0.0 | 3% |
| Betaine mg | 19 | |
| Phytosterols mg | 6 | |

In some embodiments, each serving is 3 oz (85 gram). In some embodiments, each serving is 8 oz (226 gram). In some embodiments, each serving is between 3 oz and 8 oz (e.g., 4, 5, 6, or 7 oz).

All food sources used in the food products described herein may be conventional or organic. In some embodiments, all food sources are 100% organic. The term “organic” is defined according to United States Department of Agriculture (USDA) Definition and Regulations.

Typically, the food products disclosed herein are substantially free of any non-natural, artificial ingredients, such as artificial preservatives, artificial fiber, protein isolates, and/or artificial sweeteners. Typically, the food products disclosed herein are substantially free of any concentrated ingredients, powders, extracts or any combination thereof. Typically, the food products disclosed herein are substantially free of any animal protein. Typically, the food products disclosed herein are substantially free of any animal product. The term “substantially free” as used herein means that the ingredient is present in the food product in an amount less than, for example, 0.1% by weight, 0.05% by weight, 0.01% by weight or 0.001% by weight. In some embodiments, the food products are free of any artificial ingredients, concentrated ingredients, powders, and/or extracts. In some embodiments, the food products described herein are substantially free or free of gluten, GMO, diary, soy or any combination thereof.

The pH of the food products of the invention is in the range of about 3.5 to 5.5 (e.g., about 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5) or alternatively between about 3.5 and 4.5 (e.g., 3.5, 3.6, 3.7, 3.8, 3.9, 4, 4.1, 4.2, 4.3, 4.4, 4.5), or alternatively below about 5, or alternatively below about 4.6, or alternatively about 4.1 or 4.2. This low pH below 4.2 is desirable in order to remain stable at room temperature over long periods of time, free from growth of bacteria and/or spores with minimal thermal processing.

The food products described herein can be in any form available in the art for packaged food product (liquid, semi-solid or solid), for example, a drink, a smoothie, a food blend, a frozen bar or popsicle, a sauce, a soup or a bar. It is understood that pH of the food products may vary depending on specific pasteurization condition used. It is also understood that pH of the food products may depend on the final form of the food product, which ultimately determines the process of making the food products.

A liquid can be added to the solid or semi-solid product to achieve desired consistency (e.g., a viscosity that will give a bostwick score in the range of about 4 to 10, such as 4.5). Non-limiting examples of the source of a liquid to dilute the solid or semi-solid product include one or more of the following: water, 100% coconut water, 100% juice from fruits and/or vegetables described previously, and 100% vegetable broth.

### Process of Making the Food Products

To prepare the food product described herein, one or more whole food sources are measured and combined. A mixture is then reduced by suitable techniques, such as blending, pureeing, masticating, and/or mashing the combined whole food sources. In one aspect, the whole food sources (or the mixture) should be reduced to a slurry or a homogenized blend that has a viscosity correlating to a Bostwick score in the range of about 4-10 (e.g., about 4.5, 5, 6, 7, 8, 9, 9.5) or higher. Optionally, the mixture is run through a sieve or a food mill, taking care not to remove any of the natural fiber from the food, as is currently standard in the industry. In some embodiments, the mixture is run through a series of blades to further reduce particle size.

After blending, pureeing, masticating, and/or mashing, and optionally running through a sieve or food mill or a series of blades, the mixture is pasteurized by any methods known in the art. Such methods may include, but are not limited to, conventional pasteurization methods (e.g., Ultra High Temperature Pasteurization or High Pressure Pasteurization) or any permissible methods mandated by the FDA for producing shelf-stable, low acid, acidified, or acidic foods (e.g., standard pasteurization, acidified food pasteurization). It is well known in the art that while most methods of thermal processing for purposes of pasteurization alter some of the nutrients found in fresh foods, most of the complex proteins, fiber, and other nutrients are left intact; and that Thermal Processing or High Pressure Pasteurization is a necessary part of creating a safe, convenient, ready to eat food product, by killing off bacteria and spores that could cause harm or even death to the consume. In some embodiments, the pasteurization is carried out by thermal pasteurization or acidified food pasteurization or high pressure pasteurization.

The pH of the food product can be adjusted either pre- or post-pasteurization and can be adjusted by adding foods and juices from foods that are acidic in nature, such citrus (lemon or lime), or other fruits, such as orange, mandarin, grapes, pineapple, or apple, in preference to using standard preservatives, such as ascorbic acid to create an acidified product. Single strength (Not From Concentrate) or concentrated juices may be used for acidification purposes. The pH of the final product will be in the range of about 3.5-4.3 (e.g., about 3.5, 3.6, 3.7, 3.8, 3.9, 4, 4.1, 4.2, 4.3) for some embodiments, for other embodiments the pH will be in the range of about 4.0-5.5 (e.g., about 4, 4.1, 4.2, 4.3, 4.4, 4.5, 4.6, 4.7, 4.8, 4.9, 5, 5.1, 5.2, 5.3, 5.4, 5.5).

Packaging of the final food product can be carried out according to any method known in the art.

Any natural whole food source can be utilized in this process. Exemplary whole food sources include, but are not limited to, legumes in any form (dried, raw, hydrated, cooked, roasted, boiled, toasted, steamed, split, chopped, ground, pulverized or pureed), such as lentils of any color; beans (such as lima beans, kidney beans, navy beans or white beans), chickpeas, and peas of any color; whole grains in any form (whole, raw, sprouted, cooked, boiled, steamed, roasted, toasted, ground, pulverized or pureed), such as quinoa, amaranth, barley, faro, rye, buckwheat, and rice; seeds in any form (whole, raw, sprouted, dried, hydrated, cooked, roasted, boiled, steamed, toasted, ground, chopped, pulverized), such as flax, sunflower, pumpkin, perilla, sesame, hemp and chia seeds; nuts in any form (whole, raw, roasted, boiled, steamed, toasted, ground, chopped, hydrated, pulverized, sliced), such as almonds, peanuts, cashews, walnuts, pecans, pistachios, pine nuts, macadamia nuts and hazelnuts; root vegetables in any form (whole, skinned, raw, cooked, frozen (including IQF), roasted, steamed, sautéed, baked, boiled, chopped, ground, pulverized or pureed) such as beets of any color, carrots of any color, potatoes of any color, sweet potatoes of any color, or yams of any color; whole citrus fruit in any form (raw, segmented, sliced, chopped, pulverized, masticated, pureed, cooked, frozen (including IQF), boiled, steamed, roasted) such as limes, lemons, oranges, mandarins and grapefruit; pome fruits in any form (whole, raw, dried, dehydrated, cooked, boiled, frozen (including IQF), roasted, steamed, sautéed, baked, pureed, chopped, blended or pulverized) such as apples of any variety, pears of any variety, and Asian pears; stone fruits in any form (whole, raw, dried, dehydrated, cooked, boiled, roasted, frozen (including IQF), steamed, sautéed, baked, pureed, chopped, blended, pulverized or powdered), such as peaches, nectarines, cherries, apricots and plums of any color; tropical fruits in any form (whole, raw, dried, dehydrated, frozen (including IQF), cooked, boiled, roasted, steamed, sautéed, baked, pureed, chopped, blended, masticated, or pulverized), such as mangos, papayas, pineapple, or banana; berries in any form (whole, raw, dried, dehydrated, cooked, boiled, frozen (including IQF), roasted, steamed, sautéed, baked, pureed, chopped, blended or pulverized), such as strawberries, raspberries, blackberries, mulberries and blueberries, melons in any form (whole, raw, dried, dehydrated, cooked, boiled, frozen (including IQF), roasted, steamed, sautéed, baked, pureed, chopped, blended or pulverized), such as cantaloupe, watermelon and honeydew, leafy vegetables in any form (whole, raw, cooked, boiled, roasted, steamed, frozen (including IQF), sautéed, baked, pureed, chopped, blended or pulverized) such as kale, spinach, collard greens, lettuce of any variety, and beet greens; cruciferous vegetables in any form (whole, raw, cooked, boiled, roasted, steamed, frozen (including IQF), sautéed, baked, pureed, chopped, blended or pulverized) including broccoli, cauliflower and Brussels sprouts; squash in any form (whole, raw, dried, dehydrated, frozen (including IQF), cooked, boiled, roasted, steamed, sautéed, baked, pureed, chopped, blended, or pulverized), such as acorn squash, yellow squash, zucchini, summer squash, pumpkin, and butternut squash; other vegetables in any form (whole, raw, cooked, boiled, roasted, steamed, frozen (including IQF), sautéed, baked, pureed, chopped, blended or pulverized) including green beans, asparagus and corn; herbs in any form (whole, raw, dried, dehydrated, cooked, boiled, roasted, steamed, sautéed, baked, pureed, chopped, blended, pulverized or powdered), such as mint, spearmint, sage, rosemary, thyme, or oregano; Zingiberaceaes in any form (whole, raw, dried, dehydrated, frozen (including IQF), cooked, boiled, roasted, steamed, sautéed, baked, pureed, chopped, blended, pulverized or powdered), such as ginger or turmeric, alliums in any form (whole, raw, dried, dehydrated, cooked, boiled, roasted, steamed, sautéed, frozen (including IQF), baked, pureed, chopped, blended, pulverized or powdered) such as shallots, onion of any variety and garlic, capsicums in any form (whole, raw, dried, dehydrated, cooked, frozen (including IQF), boiled, roasted, steamed, sautéed, baked, pureed, chopped, blended, pulverized or powdered), such as sweet peppers of any variety and chili peppers of any variety, coconut flesh in any form (whole, raw, dried, dehydrated, frozen (including IQF), cooked, boiled, roasted, steamed, sautéed, baked, pureed, chopped, blended, pulverized or powdered), and fungi in any form (whole, raw, dried, dehydrated, frozen (including IQF), cooked, hydrated, boiled, roasted, steamed, sautéed, baked, pureed, chopped, blended, or pulverized), such as mushrooms of any variety. All ingredients may be conventional or organic. In some embodiments, all ingredients used in the process are 100% organic.

Typically, the process described herein does not include any steps of removing any fiber from the whole food source.

In some embodiments, the process described herein uses whole food sources that are free of any refining step. In some embodiments, the process described herein does not include any refining step other than reducing the mixture into small particles and pasteurization.

The process may also include steps of adding liquid to the mixture, for example, to facilitate the blending step during the process. Exemplary types of liquid that can be used in the process include, but are not limited to, water, 100% coconut water, broth, natural juice from fruits and/or vegetables, and any combination thereof.

Typically, a majority of starting ingredients (i.e., starting whole food sources) are whole/fresh produce (including Individually Quick Frozen produce), compared to already processed (pureed, aseptic, etc.) ingredients used in other products in the market. The starting whole food sources are blended/pureed/reduced on site while they are fresh. The ingredients used in the process are exposed to minimal processing/heat. Fresh leafy vegetables and fruits are only exposed to heat at the time of pasteurization. Nothing is removed from the natural whole food (i.e., fiber, seeds, skin if edible, or other nutrients) at any time during this process.

In some embodiments, the food products described herein will take the form of a thick smoothie-like product or food blend, and be packaged in 3, 4, 5, 6, 7 or 8 oz squeeze pouches through a co-packaging facility.

In some embodiments, the food products described herein will take the form of a soup, with a higher Bostwick (more liquid—over 8 Bostwick), and be made shelf-stable through pasteurization (either pasteurization for acidified food, high temperature pasteurization, or retort), packaged in either a tetrapak box, or a food safe pouch. Each container will hold 2-3, 8 oz servings. Packaging will be carried out through a co-packer. An example might be beets, sweet potatoes, navy beans, carrots, apple, quinoa, onion, garlic, turmeric and vegetable broth.

In some embodiments, the food products described herein will take the form of a frozen treat, such as a bar or popsicle. This line of products will have lower total amounts of protein and fiber per serving (roughly 2-3 oz), and slightly higher amounts of sugar. After combining, food source(s), blending, and adjusting pH, product will be poured into molds and frozen prior to packaging. An example might be a “tropical fruit popsicle” containing pineapple, banana, quinoa, lentils, carrot juice, lemon juice, yams and sweet potatoes.

In some embodiments, the food products described will take the form of a bar. The final pureed or blended product will be poured into molds (about 60-90 g, e.g., about 61, 62, 63, 64, 65, 66, 67, 68, 69, 70, 71, 72, 73, 74, 75, 76, 77, 78, 79, 80, 81, 82, 83, 84, 85, 86, 87, 88, 89 g) and baked (roasted, cooked, etc.). In another embodiment, the food product will contain significantly less liquid, so that the product can be hand molded into the shape of a bar (about 60-85 g, e.g., about 61, 62, 63, 64, 65, 66, 67, 68, 69, 70, 71, 72, 73, 74, 75, 76, 77, 78, 79, 80, 81, 82, 83, 84, 85 g) and baked (roasted, cooked, etc.). Bars will be shelf stable, and packaged through a co-packer. An example might be sweet potatoes, yams, split peas, Ferro, carrot juice, grape juice and perilla seeds.

### EXAMPLES

### Example 1

### Product from Fresh Produce

Vegetable Broth—“A”

To a total of about 24 cups of water, add 1 onion, 1 bunch thyme, 5 average bay leaves, 5 average stalks of celery, 1½ c. beet greens, 1 shallot, ¼ c. fresh sage, 3 large carrots cubed, 2 c. kale, 5 garlic cloves, 1 lemon, ½ lime, ½ granny smith apple, 2 average stalks lemon grass, 2 T fresh ginger. All contents are mixed and brought to a boil, and then simmered for 4 to 5 hours. Alternatively, any nutritious, low sodium, organic or conventional commercially available vegetable broth may be used as Vegetable Broth “A.” Vegetable Broth “A” may also be substituted with water, or other liquids such as 100% coconut water.

As used throughout the examples, “c” refers to cup and “T” refers to tea spoon (tsp.).

Grain Mixture “A”

Mix together about 2 c. legumes such lentils, or others as listed above (can be whole, dried, split, pulverized, powdered, or rehydrated) and about 4-5 c. of Vegetable Broth “A” or water. Apply a heat source such as boil, simmer, bake, or steam, for about 10 to 30 minutes, until all Vegetable Broth “A” is absorbed by the legumes, and legumes are easily chewable (al dente to soft).

Grain Mixture “B”

Mix together about 2 c whole grains, such as quinoa, or others as listed above (can be whole, dried, sprouted, split, pulverized, powdered, or rehydrated). Heat process (e.g., boil, steam, bake, roast, simmer) for about 10-30 minutes until the grains absorb all water, and grains are chewy (al dente to soft).

Vegetable Base Mixture “A”

1½ c. vegetable broth “A”; 1½ c. grain mixture “A”; 1½ c. grain mixture “B”; 2 c. sweet potatoes and/or yams, cooked until easily penetrated with a fork (boiled, baked, roasted, steamed, grilled, pureed or sautéed). Mix together through blending, pureeing, masticating, mashing, or running mixture through a sieve or food mill, to a total of about 5 cups. Vegetable Base Mix “A” can be used fresh, or stored frozen up to 6 weeks for later use.

Vegetable Juice “A”

Vegetable Juice “A” can be the juice from any vegetable or combination of vegetables, organic or conventional, that have been run through a masticating juicing device, cold pressed, or put through a conventional juicer, in a way that removes the majority of the vegetable pulp, leaving behind the liquid from the vegetable. Vegetable Juice “A” has no added ingredients outside of the juice derived from the vegetables juiced, for example, no added flavor, no added sugar or artificial sugar, and no added colors. Vegetable Juice “A” is never concentrated or diluted. Vegetable Juice “A” can be made and used fresh, made fresh, frozen for up to 6 weeks and then thawed for use, or purchased from a commercially available source.

Fruit Juice “A”

Fruit Juice “A” can be the juice from any fruit or combination of fruits, organic or conventional, that have been run through a masticating juicing device, cold pressed, or put through a conventional juicer, in a way that removes the majority of the fruit pulp, leaving behind the liquid from the fruit. Fruit Juice “A” has no added ingredients outside of the juice derived from the fruits juiced, for example, no added flavor, no added sugar or artificial sugar, and no added colors. Fruit Juice “A” is never concentrated or diluted. Fruit Juice “A” can be made and used fresh, made fresh, frozen for up to 6 weeks and then thawed for use, or purchased from a commercially available source.

Citrus, Beet, Ginger Product from Vegetable Base Mixture

To one part fresh vegetable base mixture “A,” add 0.25 parts vegetable broth “A”, 0.25 parts fresh or frozen vegetable juice “A,” 0.25 parts fresh or frozen fruit juice “A,” 0.25 parts coconut water, chopped, cooked beets (about 2.1 oz), ⅔ lime (about 1.2 oz) or lime juice, 1½ mandarin oranges (about 3.2 oz) or 3.2 oz conventional orange, ⅓ medium navel orange (about 1.9 oz), ⅓ medium banana (about 1.9 oz), about 0.5 oz fresh mint leaves, 1½ teaspoon minced ginger root, and ¼ cup chia seeds (can be dry or hydrated in liquids first). Blend, puree, or otherwise reduce mixture into a slurry with a Bostwick score between 4.0-10.0. Makes roughly 3 cups of final product, or six, 4 oz servings. Pasteurize slurry for shelf stability, according to USDA protocol for pH.

### Example 2

### Product from Frozen Produce

Frozen produce can be used when fresh produce is not available. The following is an example of a product made from frozen components.

Orange Beet Ginger Product from Frozen Vegetables

To one part (fresh or thawed from frozen) vegetable base mix “A,” add 0.25 parts fresh or thawed from frozen vegetable broth “A,” 0.5 parts fresh or thawed from frozen vegetable juice “A,” 0.25 parts fresh or frozen fruit juice “A,” chopped, cooked beets thawed from frozen (about 2.1 oz), ⅔ lime (about 1.2 oz) or lime juice fresh or thawed from frozen, 3.2 oz conventional orange, about 1.9 oz thawed from frozen single strength (not from concentrate (NFC)) orange juice, ⅓ medium banana (about 1.9 oz), about 0.5 oz Individually Quick Frozen (IQF) mint leaves, 1½ teaspoon minced ginger root (thawed from frozen), and ¼ cup chia seeds (can be added dry or hydrated in liquids first). Blend, puree, or otherwise reduce mixture into a slurry with a Bostwick score between 4.0-10.0. Makes roughly 3 cups of final product, or six, 4 oz servings. Pasteurize slurry for shelf stability, according to USDA protocol for pH.

Sweet Potato Pear Product

To 1 c Vegetable Base Mixture “A” (fresh or thawed from frozen), add to it ¼ c. banana, ⅓ c. roasted pear (e.g., d'anjou pear, about 2.25 oz in size), ⅛ c. cantelope, ¼ c. coconut juice, ¼ c. carrot juice, ¼ c. vegetable broth A, 1.75 oz SS, NFC orange juice, ⅓ c. roasted yellow beets (cooked weight), ¼ c. roasted carrots (cooked weight), ¼ c. mango (about 1.8 oz in size), and ¼ c. chia (about 1.36 oz) either dry or hydrated in liquids.

Spinach Pear Product

To 1 c. of Vegetable Base Mixture “A”, add 2½ c. spinach (about 5 oz.), ½ c. kale (about 2.5 oz), ⅓ c. raw pear (e.g., d'angou pear, about 3 oz.), ⅓ c. raw yellow pepper, ¼ c. orange (e.g., navel orange), ¼ c. grapes (e.g., red grapes), ¼ c. raw carrots, ⅛ c. cantaloupe juice, ¼ c. banana, ¼ c. chia seeds, ¼ c. coconut water, and ⅔ c. whole lemon or ⅓ c lemon juice, to a total of about 3.5 cups.

### Example 3

### Process to Make Pouched Food Products

Procure all fresh produce, grains, legumes, seeds, nuts, juices and broth according to formula. Cook dried grains and legumes in liquid (water, coconut water, or broth) for 20-30 minutes until soft. Set aside. In some instances, hydrate seeds for at least 10 minutes in liquid using a seed to liquid ratio ranging from 1:5 up to 1:12. Liquids for hydration can include water, coconut water, broth, or natural juices from fruits/vegetables. Using a masticating (or other) juicer, extract natural juice from fruits and vegetables as per formula. Wash and dice all other root vegetables, leafy green vegetables, cruciferous vegetables, other vegetables, herbs, fruit, etc. Soften root vegetables through exposure to heat (steam, dry heat, direct heat, etc). Combine ingredients according to formula (cooked grains and legumes, vegetable/fruit juices, hydrated seeds, cleaned and diced fruit, vegetables, and herbs, and softened root vegetables), and blend together using paddle type mixer. Transfer mixture to food reduction equipment (food mill, sieve, rotating blades, desiccator, etc.). Test Bostwick and pH to ensure the proper range has been achieved; add more liquid and/or acidic juice as necessary. Transfer blended slurry to kettles for final mixing, pasteurization and packaging in pouches (accomplished in same step for pouches). In some embodiments, food blend is pumped through a tube-in-tube (food in inner tube, hot water jacket in outer tube) configuration at constant temperature (˜195-200 F degrees) for 10 minutes in transit to pouch filler. Pouches are filled to 4 oz. Nitrogen gas is puffed into mouth of pouch to remove oxygen before adding a cap to the pouch. Capped pouches are transferred through a water bath (195-200 F degrees for 3 minutes) to sterilize pouches.

For the food products in the form of a thick smoothie-like product or food blend, they are packaged in 3.5-4.5 oz squeeze pouches through a co-packer.

For the food products in the form of a soup, with a higher Bostwick (more liquid—over 10 Bostwick), they are made shelf-stable through pasteurization (standard pasteurization for acidified food, high temperature pasteurization, high pressure pasteurization, or retort), and packaged in either a tetrapak box, or a food safe pouch. Each container holds 2-3, 8 oz servings. Packaging is carried out through a co-packer. An example might be beets, sweet potatoes, navy beans, carrots, apple, quinoa, onion, garlic, turmeric and vegetable broth.

For the food products in the form of a frozen treat, such as a bar or popsicle, this line of products have lower total amounts of protein and fiber per serving (roughly 2-3 oz), and slightly higher amounts of sugar. After combining, food source(s), blending, and adjusting pH, product is poured into molds and frozen prior to packaging. An example might be a “tropical fruit popsicle” containing pineapple, banana, quinoa, lentils, carrot juice, lemon juice, yams and sweet potatoes.

For the food products in the form of a bar, the final pureed product is poured into molds (about 80-90 g) and baked (roasted, cooked, etc.). In some instances, the food product contains significantly less liquid, so that the product can be molded into a bar (about 60-75 g) and baked (roasted, cooked, etc.). Bars will be shelf stable, and packaged through a co-packer. An example might be sweet potatoes, yams, split peas, Ferro, carrot juice, grape juice and perilla seeds.

### Example 4

### Process of Production

1. Common process for all the products (“prep for all SKUs”):

(1) Weigh & Cook:
Quinoa/Lentil Mix for all SKUs
Make Quinoa/Lentil Mix (about 1000-1500 lbs cooked) by combining dry
quinoa, dry split red lentils and water in the Lee Kettle. Bring to boil, then
reduce to simmer for 20-25 minutes until water mostly absorbed.
Measure weight of end product, then divide appropriate portion for each
product.
Set aside for later
(2) Measure Chia & liquids
For each SKU, measure the following:
Vegetable broth (total about 1000-1200 lbs) and aliquot appropriate
amount for each product.
Add Carrot Juice to vegetable broth (total about 800-1000 lbs) and
aliquot appropriate amount for each product.
Add Water to Carrot Juice & Veggie Broth (total about 200-300 lbs)
and aliquot appropriate amount for each product.
Measure Chia Seeds and set aside (total about 500-600 lbs) and set
aside appropriate amount for each product.
Measure Lemon Juice and set aside (total about 500-600 lbs) and
aliquot appropriate amount for each product.
Measure Lime Juice and mix with Lemon juice for Product 3.
Wash, weigh and sort root vegetables:
Sweet Potato (total about 500-600 lbs) and set aside appropriate
amount for each product.
Yams (total about 250-350 lbs) and set aside appropriate amount for
each product.
Red Beet (total about 650-800 lbs) and set aside appropriate amount
for the product(s) that contain it.
Yellow Beet (total about 250-350 lbs) set aside appropriate amount for
the product(s) that contain it.
Carrot (total about 200-250 lbs) set aside appropriate amount for the
product(s) that contain it.
(3) Measure Cold Fruit/Veggie Mix
Fruit/Veggie Mix
Pear--Wash, destem, and weigh (total about 250-350 lbs) and set aside
appropriate amount for each product that needs it.
Banana (total about 250-350 lbs)--measure and add to pear and set
aside appropriate amount for each product.
Spinach (total about 200-300 lbs)--measure and add to fruit mix and
set aside appropriate amount for each product.
Ground Whole Orange (total about 150-250 lbs) and set aside
appropriate amount for each product.
Mango (total about 50-100 lbs)--measure and add to fruit mix and set
aside appropriate amount for each product.
Mint leaves (total about 50-100 lbs)--wash and destem and set aside
appropriate amount for each product.
(4) Measure Juices
Measure Juices, then set aside
Orange Juice (total about 300-400 lbs) and aliquot appropriate amount
for each product.
Apple Juice (total about 300-400 lbs) and aliquot appropriate amount
for each product.
(5) Other ingredients--measure then set aside
Sea Salt (total about 5-15 lbs) and set aside appropriate amount for
each product.
Cinnamon (total about 1-10 lbs)--measure then set aside appropriate
amount for each product.
Minced Ginger (total about 10-20 lbs). Set aside appropriate amount
for each product.

2. Specific process for making Product 1, 2, and 3, respectfully.

(1) Continued process for making product 1:

Q/L Mix Product 1
Make Quinoa/Lentil Mix as per “prep for all SKUs”, and measure amount for Product 1.
Chia Mix Product 1
Chia Seed
Carrot Juice
Vegetable Broth
Water
Lemon Juice
Root Vegetable Mix Product 1
Steam root vegetables
Yellow Beets
White Sweet Potato
Yams
Carrot
Cold Fruit and Vegetable Mix Product 1
Add fruit juices, seasonings, & Q/L mixture to chia mixture Product 1, mixing well.

Pears
Banana
Mango
Apple & Orange Juice
Cinnamon
Sea Salt
Q/L Mix
Chia Mix

Add Product 1 steamed root vegetable mix to cold mixture (chia/fruit/juices/etc.). Mix until combined, then
grind/blend

| | |
|---|---|
| Remaining water | Add hot water, and only what's |
| | necessary to reach Bostwick |
| | range. |

Qualification
Add additional lemon juice and/or water to bring mixture to the following range:

| | |
|---|---|
| pH range | 3.80-4.00 |
| Bostwick range | 4.5-6.0 at temperature; 3.5-4.0 at room |
| | temperature. |

| | |
|---|---|
| Brix range | Initially just note values |

Heat and process as standard protocol for pouched acidified foods with pH range about 4.10-4.18.
Fill pouches with 4 oz of Product 1 mixture

(2) Continued process for making product 2:

Q/L Mix Product 2
Make Quinoa/Lentil Mix as per “prep for all SKUs”.
Chia Mix Product 2
Chia Seed
Carrot Juice
Vegetable Broth
Water
Lemon Juice
Root Vegetable Mix Product 2
Steam root vegetables
Red Beets
White Sweet Potato
Yams
Cold Fruit and Vegetable Mix Product 2
Take Product 2 fruit mixture from “prep for all SKUs”
Banana
Spinach
Pear
Apple & Orange Juice
Balsamic Vinegar
Sea Salt
Q/L Mix
Chia Mix
Add Product 2 steamed root vegetable mix to cold mixture (chia/fruit/juices/etc.). Mix until combined,
then grind/blend
Add remaining water (add hot WATER during the heating process) as necessary to reach Bostwick range.
Remaining Chia Mix
Remaining water
Pump mixture into pouch line kettles
Qualification
Check pH and Bostwick. Adjust using appropriate liquids (lemon juice and/or water).

| | |
|---|---|
| pH range | 3.80-4.10 |
| Bostwick range | 4.5-6.0 at temperature (3.5-4.0 at room temperature) |

| | |
|---|---|
| Brix range | Initially just note values |

Heat and process as standard protocol for pouched acidified foods within the appropriate pH range.
Fill pouches with 4 oz of Product 2 mixture

(3) Continued process for making product 3:

Q/L Mix Product 3
Follow mixing/cooking instructions on “Prep for all SKUs”
Chia Mix Product 3
Chia
Carrot Juice
Vegetable Broth
Water
Lemon Juice
Lime Juice
Root Vegetable Mix Product 3
Take Product 3 Root Mixture as specified in “prep for all SKUs” and steam. Add to chia mixture for product 3
Red Beet
White Sweet Potato
Yams
Cold Fruit Mix Product 3
Fresh mint
Banana
Measure and add to Chia Mixture
Mint & Banana Mix
Orange
Ginger
Apple & Orange Juice
Sea Salt
Q/L Mix
Steamed Root Veggies
Add steamed root vegetable mix to cold fruit and veggie/hydrated chia mixture. Mix until combined, then blend
Add remaining hot water as necessary during heating process.
Remaining water
Qualification
Check pH and Bostwick. Adjust using appropriate liquids (lemon/lime juice and/or water).

| | |
|---|---|
| pH range | 3.80-4.10 |
| Bostwick range | 4.5-6.0 at temperature (3.5-4.0 at room temperature) |

| | |
|---|---|
| Brix range | Initially just note values |

Heat and process as standard protocol for pouched acidified foods with pH range about 4.10-4.18.
Fill pouches with 4 oz of Product 3 mixture

It should be understood that although the present invention has been specifically disclosed by various embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

What is claimed is:

1. A food product, each serving comprising: about 2-10 grams of protein from a first whole food source, about 2-10 grams of fiber from a second whole food source, and about 2-15 grams of sugar from at least one of whole fruits and/or whole vegetables, wherein the food product is a thermally processed and shelf-stable food product.

2. The food product of claim 1, wherein the first whole food source is selected from the group consisting of legume, whole grain, seed, nut, and any combination thereof.

3. The food product of claim 1, wherein the second whole food source is selected from the group consisting of legume, whole grain, seed, husk, nut, root vegetable, leafy green vegetable, fresh herb, citrus fruit, stone fruit, pome fruit and any combination thereof.

4. The food product of claim 1, wherein the sugar comprises fructose from at least one of whole fruits and whole vegetables, or the juices from at least one of whole fruits and whole vegetables.

5. The food product of claim 3, wherein the legume is bean, pea or lentil.

6. The food product of claim 3, wherein the seed is chia seed, flax seed, perilla seed or psyllium seed.

7. The food product of claim 3, wherein the root vegetable is sweet potato, beet, or carrot.

8. The food product of claim 1, further comprising about 0.5-2 grams of natural omega-3-fatty acid.

9. The food product of claim 1, further comprising about 10-100 micrograms of natural folate.

10. The food product of claim 1, further comprising one or more natural supplemental vitamins and/or minerals.

11. The food product of claim 10, wherein the vitamin and/or mineral are provided from one or more natural sources selected from the group consisting of a Vitamin B-9 source, a Vitamin C source, a Vitamin A source, a Vitamin K source, a Choline source, a Vitamin B6 source, a Calcium source, a Potassium source, a Magnesium source, a Manganese source, a Selenium source, a Zinc source, a Niacin source, a Phosphorus source, a Pantothenic Acid source, a Riboflavin source, a Thiamin source, and a Betaine source.

12. The food product of claim 1, each serving further comprising about 1,000-2,000 mg Calcium; about 800-2,000 IU Vitamin D; about 800-1,500 mg phosphorus; about 5-20 milligrams silica; about 200-1,000 micrograms Chromium; about 500-3,000 milligrams Vitamin C; about 800-1,200 Vitamin K1; and/or about 45-180 micrograms menaquinone 7 (MK7).

13. The food product of claim 1, wherein the food product has a pH value of about 3.5 to about 5.5.

14. The food product of claim 1, wherein the food product has a pH value of about 3.5 to about 4.3.

15. The food product of claim 1, wherein the food product is in a form of a drink, a smoothie, a food blend, a frozen bar or popsicle, a sauce, a soup or a bar.

16. The food product of claim 1, wherein the food product is substantially free of one or more ingredients selected from the group consisting of artificial preservatives, artificial fiber, protein isolates, and artificial sweeteners.

17. The food product of claim 1, wherein some or all of the food sources are conventional.

18. The food product of claim 1, wherein some or all of the food sources are organic.

19. A food product, each serving comprising: about 2-10 grams of protein from a first whole food source, about 2-10 grams of fiber from a second whole food source, and about 2-15 grams of sugar from at least one of whole fruits and/or whole vegetables, wherein the food product is a high pressure processed food product.

20. A process for producing a food product, comprising:
a) measuring two or more whole food sources;
b) optionally cooking or softening the whole food sources;
c) combining the whole food sources;
d) providing a mixture by blending the whole food sources;
e) reducing the mixture into smaller particles;
f) adding citrus juice to make the mixture acidic;
g) pasteurizing the mixture for shelf stability; and
h) packaging the mixture, thereby producing the food product.

21. The process of claim 20, further comprising running the mixture through a sieve or a food mill before pasteurizing the mixture.

22. The process of claim 20, further comprising running the mixture through a series of blades to further reduce particle size.

23. The process of claim 20, wherein the pasteurizing the mixture is carried out by thermal pasteurization or high pressure pasteurization.

24. The process of claim 20, further comprising adjusting the pH of the food product.

25. The process of claim 24, wherein the adjusting the pH is before pasteurizing the mixture.

26. The process of claim 24, wherein the adjusting the pH is after pasteurizing the mixture.

27. The process of claim 24, wherein the adjusting the pH is carried out by adding an effective amount of a natural fruit or juice from at least one naturally acidic fruit.

28. The process of claim 20, wherein the whole food source is selected from the group consisting of legume, whole grain, seed, nut, husk, root vegetable, leafy green vegetable, fresh herb, and fruit.

29. The process of claim 20, wherein the process does not include removing any fiber from the whole food source.
